(19) United States
(12) Patent Application Publication
(10) Pub. No.: US 2026/0321986 A1
(43) Pub. Date: Oct. 15, 2026

(54) ANTENNA, PHASE SHIFTER, AND BASE STATION

(71) Applicant: HUAWEI TECHNOLOGIES CO., LTD., Shenzhen (CN)

(72) Inventors: Zhi Gong, Dongguan (CN); Chaochao Li, Xi'an (CN); Xiaodong Wei, Xi'an (CN); Fuwei Lei, Xi'an (CN); Qiqiang Gao, Dongguan (CN)

(73) Assignee: HUAWEI TECHNOLOGIES CO., LTD., Shenzhen (CN)

(21) Appl. No.: 19/699,509

(22) Filed: Jun. 5, 2026

Related U.S. Application Data
(63) Continuation of application No. PCT/CN2024/126860, filed on Oct. 23, 2024.

(30) Foreign Application Priority Data
Dec. 8, 2023 (CN) 202311693048.0

(51) Int. Cl. H01Q 13/20; H01Q 1/24; H01Q 15/14

(52) U.S. Cl. CPC H01Q 13/206; H01Q 1/246; H01Q 15/14

(57) ABSTRACT

An antenna includes: a reflection plate, including a first surface and a second surface; a radiating element array, disposed on the first surface of the reflection plate; an end cover, disposed at an end of the reflection plate in a longitudinal direction; a connector, disposed on the end cover; a feeding network, connected to the connector and the radiating element array, where the feeding network includes a phase shifter and a transmission line, and the transmission line includes a flat transmission line for signal transmission between the connector and the phase shifter; and a transmission module, disposed on the second surface of the reflection plate and adjacent to the end cover, where the transmission module is configured to drive the phase shifter to execute a phase shift, and a portion of the flat transmission line is located between the transmission module and the reflection plate.

### CROSS-REFERENCE TO RELATED APPLICATIONS

This application is a continuation of International Application No. PCT/CN2024/126860, filed on Oct. 23, 2024, which claims priority to Chinese Patent Application No. 202311693048.0, filed on Dec. 8, 2023. The disclosures of the aforementioned applications are hereby incorporated by reference in their entireties.

### TECHNICAL FIELD

Embodiments of this application relate to the field of communication technologies, and in particular, to an antenna, a phase shifter, and a base station.

### BACKGROUND

With rapid development of the wireless communication industry, energy consumption of a communication system continue to escalate alongside the rollout of large-scale mobile broadband and diverse 5G applications. Against the backdrop of “carbon peak” and “carbon neutrality” development strategies proposed by countries around the world, green and energy-efficient wireless communication networks have become imperative, making energy efficiency a key indicator for the communication system. In addition, the relentless pursuit of 5G network performance necessitates continuous optimization and enhanced energy efficiency in base station antennas, thereby enabling better network coverage.

### SUMMARY

Embodiments of this application provide an antenna, a phase shifter, and a base station to improve energy efficiency of the antenna.

According to one aspect of this application, an antenna is provided, including: a reflection plate, including a first surface and a second surface; a radiating element array, disposed on the first surface of the reflection plate; an end cover, disposed at an end of the reflection plate in a longitudinal direction; a connector, disposed on the end cover; and a feeding network, connected to the connector and the radiating element array, where the feeding network includes a phase shifter and a transmission line, and the transmission line includes a flat transmission line for signal transmission between the connector and the phase shifter; and a transmission module, disposed on the second surface of the reflection plate and adjacent to the end cover, where the transmission module is configured to drive the phase shifter to execute a phase shift, where a portion of the flat transmission line is located between the transmission module and the reflection plate.

In comparison with a related technology, in the antenna in this embodiment of this application, because a cross-sectional area of the flat transmission line may be designed to be larger, and a proportion of an insulating medium in a structure of the flat transmission line may be designed to be smaller, a transmission loss of a main feeder of the feeding network can be reduced, thereby improving energy efficiency of the antenna. In addition, because a portion of the flat transmission line is located between the transmission module and the reflection plate, that is, the portion of the flat transmission line is routed between the transmission module and the reflection plate, the flat transmission line may be disposed through a gap between the transmission module and the reflection plate. In this way, an internal structure of the antenna is more compact and tidier.

In some embodiments, the flat transmission line includes a signal transmission strip line and a ground plane disposed apart from the signal transmission strip line, where a width direction of the signal transmission strip line is parallel to the reflection plate, or a thickness direction of the signal transmission strip line is parallel to the reflection plate. A specific disposition manner of the flat transmission line may be flexibly selected and designed in combination with a disposition manner of the phase shifter, and all the foregoing beneficial effects can be obtained.

In some embodiments, an air gap is provided between the signal transmission strip line and the ground plane. When the air gap is designed between the signal transmission strip line and the ground plane, a volume of the insulating medium in the structure of the flat transmission line is small, so that a signal transmission loss can be reduced.

In some embodiments, the flat transmission line is a strip line, and the ground plane includes two ground plates disposed parallel to the signal transmission strip line, where the signal transmission strip line is located between the two ground plates, the signal transmission strip line is spaced apart from the two ground plates by a plurality of insulating support structures, and the air gap is separately provided between the signal transmission strip line and the two ground plates; or
the flat transmission line is a microstrip line, the ground plane includes one ground plate disposed parallel to the signal transmission strip line, where the signal transmission strip line is spaced apart from the one ground plate by a plurality of insulating support structures, and the air gap is provided between the signal transmission strip line and the one ground plate; or
the flat transmission line is a coplanar waveguide, the ground plane includes a first wide side surface and a second wide side surface that are disposed in parallel, and a first narrow side surface and a second narrow side surface that are disposed in parallel, where the first wide side surface, the second wide side surface, the first narrow side surface, and the second narrow side surface form a rectangular cavity, an air gap is provided in the rectangular cavity, the first wide side surface has a strip-shaped opening, the signal transmission strip line is located in the strip-shaped opening, and the signal transmission strip line is spaced apart from the second wide side surface by a plurality of insulating support structures.

The flat transmission line may be any one of the strip line, the microstrip line, or the coplanar waveguide. A design of an air gap structure of the flat transmission line makes a volume of an insulating medium in the flat transmission line be small, thereby further reducing a transmission loss of the main feeder.

In some embodiments, the flat transmission line is a strip line, and the ground plane includes two ground plates disposed to parallel the signal transmission strip line, where the signal transmission strip line is located between the two ground plates, and an insulating medium is filled between the signal transmission strip line and the two ground plates; or
the flat transmission line is a microstrip line, the ground plane includes one ground plate disposed to parallel the signal transmission strip line, and an insulating medium is filled between the signal transmission strip line and the one ground plate; or
the flat transmission line is a coplanar waveguide, the ground plane includes a first wide side surface and a second wide side surface that are disposed in parallel, and a first narrow side surface and a second narrow side surface that are disposed in parallel, where the first wide side surface, the second wide side surface, the first narrow side surface, and the second narrow side surface form a rectangular cavity, the rectangular cavity is filled with an insulating medium, the first wide side surface has a strip-shaped opening, and the signal transmission strip line is located in the strip-shaped opening.

The flat transmission line may be any one of the strip line, the microstrip line, or the coplanar waveguide. In comparison with the related technology, because a cross-sectional area of the flat transmission line may be designed to be larger, and a proportion of an insulating medium in the structure may be designed to be smaller, a transmission loss of the main feeder of the feeding network can be reduced, thereby improving energy efficiency of the antenna.

In some embodiments, the flat transmission line is a strip line, the ground plane includes a first wide side surface and a second wide side surface that are disposed in parallel, and a first narrow side surface and a second narrow side surface that are disposed in parallel, where the first wide side surface, the second wide side surface, the first narrow side surface, and the second narrow side surface form a rectangular cavity, the signal transmission strip line is located in the rectangular cavity and disposed to parallel the first wide side surface and the second wide side surface, and an insulating medium is filled in or an air gap is provided in the rectangular cavity. In this embodiment, the rectangular cavity may provide a better shielding protection effect for the signal transmission strip line, thereby helping improve signal transmission stability.

In some embodiments, the transmission line includes at least two flat transmission lines that extend in parallel and are configured to transmit signals in different polarization directions. When the antenna includes at least two polarization directions, signals in different polarization directions need to be transmitted through different flat transmission lines. This embodiment supports a multi-polarization design of the antenna, so that the antenna has higher signal sending and receiving efficiency.

In some embodiments, ground planes of the at least two flat transmission lines are integrally connected to each other. In this way, structures of the at least two flat transmission lines are compact, so that space occupation can be reduced, and the internal structure of the antenna is tidy.

In some embodiments, the reflection plate is grounded, the width direction of the signal transmission strip line is parallel to the reflection plate, and at least a portion of the ground plane is integrated into the reflection plate. This can simplify a structure of the flat transmission line, make processing and preparation easier, and make routing and layout easier.

In some embodiments, the phase shifter includes an external conductor cavity that is grounded, and a phase shift component and a phase shift circuit that are disposed in the external conductor cavity, where the phase shift component is configured to be driven by the transmission module to execute a phase shift, the phase shift circuit includes an input/output main line, the signal transmission strip line is connected to the input/output main line, at least a portion of the signal transmission strip line is located in the external conductor cavity, and the ground plane and the external conductor cavity are integrally connected to each other. In this embodiment, at least one section of the flat transmission line is integrated with the phase shifter, and the signal transmission strip line is connected to the input/output main line inside the phase shifter. This can not only reduce a signal transmission loss, but also simplify an internal structure of the antenna, so that the internal structure of the antenna is tidier.

In some embodiments, the signal transmission strip line and the input/output main line are welded, integrally connected to each other, or connected to each other through a bridge. The signal transmission strip line and the input/output main line may be flexibly designed based on a specific routing manner of the signal transmission strip line and the input/output main line. For example, in some embodiments, the signal transmission strip line of the flat transmission line and the input/output main line overlap with each other. In this case, the signal transmission strip line of the flat transmission line and the input/output main line may be connected to each other through laser welding. For example, in some embodiments, the signal transmission strip line of the flat transmission line and the input/output main line may be integrally connected to each other, without subsequent assembly. For example, in some embodiments, the signal transmission strip line of the flat transmission line and the input/output main line are spaced apart from each other. In this case, the signal transmission strip line of the flat transmission line and the input/output main line may be connected through a bridge.

In some embodiments, the external conductor cavity includes a plurality of sub-cavities, where the input/output main line and at least a portion of the signal transmission strip line are located in a same sub-cavity; or the input/output main line and at least a portion of the signal transmission strip line are located in different sub-cavities. When the input/output main line and the at least a portion of the signal transmission strip line are located in a same sub-cavity, the input/output main line and the at least a portion of the signal transmission strip line may be integrally connected or connected through laser welding. In this design, a structure is simplified and processing and preparation are facilitated. When the input/output main line and the at least a portion of the signal transmission strip line are located in different sub-cavities, a shielding effect of a cavity wall of the sub-cavity may be used to reduce resonance caused when the signal transmission strip line and the input/output main line transmit a high-frequency signal, thereby improving working stability of the phase shift circuit.

In some embodiments, the transmission module is disposed opposite to one or more radiating elements that are in the radiating element array and adjacent to the end cover. In this design, compactness of the radiating element array disposed on the reflection plate can be improved, and a multi-frequency design of the antenna is facilitated.

In some embodiments, an end of the flat transmission line away from the phase shifter extends, in the longitudinal direction, between the end cover and a first radiating element adjacent to the end cover; or an end of the flat transmission line away from the phase shifter extends, in the longitudinal direction, between a first radiating element and a second radiating element that are adjacent to the end cover. In this design, the end of the flat transmission line away from the phase shifter may be as close as possible to the end cover, so that the flat transmission line is more easily connected to and assembled with components such as the connector easier.

In some embodiments, the flat transmission line is fastened to at least one of the reflection plate, the transmission module, or the phase shifter through an insulating line clamp; or the flat transmission line includes a plurality of insulating mounting parts, and the plurality of insulating mounting parts are fastened to at least one of the reflection plate, the transmission module, or the phase shifter. In these embodiments, the flat transmission line can be reliably and easily mounted, and the flat transmission line can be easily and precisely routed.

In some embodiments, the connector and an end of the flat transmission line away from the phase shifter are connected by welding, by plug-in, by a fastener, or by a flexible cable; or the feeding network further includes a function extension component, where the function extension component is disposed on the end cover, or the function extension component is disposed between the end cover and the transmission module, the connector is connected to the function extension component, and the function extension component and an end of the flat transmission line away from the phase shifter are connected by welding, by plug-in, by a fastener, or by a flexible cable. The flat transmission line may be directly connected to the connector, or may be indirectly connected to the connector through an intermediary component. A connection structure between the flat transmission line and the connector may be flexibly designed according to a product requirement.

In some embodiments, a width direction of the phase shifter is parallel or orthogonal to the reflection plate, where the phase shifter includes the external conductor cavity that is grounded, the phase shift component and the phase shift circuit that are disposed in the external conductor cavity, and a cavity height direction of the external conductor cavity is defined as the width direction of the phase shifter. When the width direction of the phase shifter is parallel to the reflection plate, because a size in the width direction of the phase shifter is small, a size occupied by the phase shifter in the width direction is small accordingly. When the width direction of the phase shifter is orthogonal to the reflection plate, because the size in the width direction of the phase shifter is small, a size occupied by the phase shifter in a direction orthogonal to the reflection plate is small accordingly. A disposition manner of the phase shifter may be flexibly selected and designed based on an internal structure of the antenna.

In some embodiments, the phase shifter is disposed on the second surface of the reflection plate, the width direction of the phase shifter is parallel to the reflection plate, and the phase shifter includes a first portion and a second portion that protrudes from the first portion, where the second portion extends between the transmission module and the reflection plate; and the flat transmission line includes a first extension section, a second extension section, and a third extension section that are sequentially connected, where the first extension section is located between the transmission module and the second portion, and the third extension section is located on a side of the first portion away from the reflection plate. In this embodiment, the width direction of the phase shifter is parallel to the reflection plate. Because a size in the width direction of the phase shifter is small, a size occupied by the phase shifter in the width direction is small accordingly. The second portion of the phase shifter protrudes from the first portion and extends between the transmission module and the reflection plate. In this design, in one aspect, the transmission line between the phase shifter and each radiating element may be shortened as much as possible, to reduce a signal transmission loss as much as possible. In another aspect, because the phase shifter is closer to the end cover, a routing length of the flat transmission line can be reduced, to reduce the signal transmission loss as much as possible. In still another aspect, the internal structure of the antenna may be more compact.

In some embodiments, the phase shifter is disposed on the second surface of the reflection plate, and the width direction of the phase shifter is parallel to the reflection plate; and the flat transmission line and the phase shifter are laid out on the second surface of the reflection plate. In this embodiment, because a size in the width direction of the phase shifter is small, a size occupied by the phase shifter in the width direction is small accordingly. The flat transmission line may be approximately in a “straight-line” shape, or may be in another shape in a plane parallel to the reflection plate. A structural form of the flat transmission line may be flexibly designed.

In some embodiments, the phase shifter is disposed on the second surface of the reflection plate, and the width direction of the phase shifter is orthogonal to the reflection plate; and a portion of the phase shifter extends between the transmission module and the reflection plate, and a portion of the flat transmission line is located between the transmission module and the phase shifter. In this embodiment, because a size in the width direction of the phase shifter is small, a size occupied by the phase shifter in a direction orthogonal to the reflection plate is small accordingly. A portion of the phase shifter extends between the transmission module and the reflection plate. In this design, in one aspect, the transmission line between the phase shifter and each radiating element may be shortened as much as possible, to reduce a signal transmission loss as much as possible. In another aspect, because the phase shifter is closer to the end cover, a routing length of the flat transmission line can be reduced, to reduce the signal transmission loss as much as possible. In still another aspect, the internal structure of the antenna may be more compact.

In some embodiments, the phase shifter is disposed on the first surface of the reflection plate, and the width direction of the phase shifter is orthogonal to the reflection plate; the radiating element array is located on a side of the phase shifter away from the reflection plate; and the flat transmission line is connected to the phase shifter through an electrical connection structure that penetrates the reflection plate. In this embodiment, because a size in the width direction of the phase shifter is small, a size occupied by the phase shifter in a direction orthogonal to the reflection plate is small accordingly. The phase shifter is disposed on the first surface of the reflection plate, and may be closer to the end cover. In one aspect, it is more convenient to connect the phase shifter to each radiating element, and a transmission line between the phase shifter and each radiating element may be shortened as much as possible, to reduce a signal transmission loss as much as possible. In another aspect, a routing length of the flat transmission line may be reduced, to reduce the signal transmission loss as much as possible. In still another aspect, the internal structure of the antenna may be more compact.

According to one aspect of this application, a phase shifter is provided, where the phase shifter is used in an antenna, and the phase shifter includes: an external conductor cavity, where the external conductor cavity is grounded; a phase shift component, disposed in the external conductor cavity and configured to be driven by a transmission module of the antenna to execute a phase shift; a phase shift circuit, disposed in the external conductor cavity, where the phase shift circuit includes an input/output main line; and a flat transmission line, including a signal transmission strip line and a ground plane spaced apart from the signal transmission strip line, where the signal transmission strip line is connected to the input/output main line, at least a portion of the signal transmission strip line is located in the external conductor cavity, and the ground plane and the external conductor cavity are integrally connected to each other.

The flat transmission line of the phase shifter may be used as a main feeder of the antenna. In comparison with a conventional round cable, a cross-sectional area of the flat transmission line may be designed to be larger, and a volume proportion of an insulating medium in the structure may be designed to be smaller. Therefore, a transmission loss is smaller, and energy efficiency of the antenna is improved. When the flat transmission line is routed between the transmission module and the reflection plate of the antenna, the flat transmission line may be disposed through a gap between the transmission module and the reflection plate. In this way, the internal structure of the antenna may be more compact and tidier.

In some embodiments, the signal transmission strip line and the input/output main line are welded, integrally connected to each other, or connected to each other through a bridge. A connection structure of the signal transmission strip line and the input/output main line may be flexibly designed based on a specific routing manner of the signal transmission strip line and the input/output main line.

In some embodiments, the external conductor cavity includes a plurality of sub-cavities, where the input/output main line and at least a portion of the signal transmission strip line are located in a same sub-cavity; or the input/output main line and at least a portion of the signal transmission strip line are located in different sub-cavities. When the input/output main line and the at least a portion of the signal transmission strip line are located in a same sub-cavity, input/output main line and the at least a portion of the signal transmission strip line may be integrally connected or connected through laser welding. In this design, a structure is simplified and processing and preparation are facilitated. When the input/output main line and at least a portion of the signal transmission strip line are located in different sub-cavities, a shielding effect of a cavity wall of the sub-cavity may be used to reduce resonance caused when the signal transmission strip line and the input/output main line transmit a high-frequency signal, thereby improving working stability of the phase shift circuit.

In some embodiments, the flat transmission line is one of a strip line, a microstrip line, or a coplanar waveguide. Because the cross-sectional area of the flat transmission line may be designed to be larger, and the proportion of the insulating medium in the structure of the flat transmission line may be designed to be smaller, a transmission loss of a main feeder of a feeding network can be reduced, thereby improving energy efficiency of the antenna. The flat transmission line may be designed through an air gap structure with reference to some of the foregoing embodiments, to reduce a volume proportion of the insulating medium, thereby further reducing the transmission loss of the main feeder.

According to one aspect of this application, a base station is provided, including the antenna according to any one of the foregoing embodiments. Based on the foregoing design, the antenna of the base station has high energy efficiency and good structural compactness, so that the base station can obtain better network coverage performance.

### BRIEF DESCRIPTION OF DRAWINGS

FIG. 1A is a diagram of a structure of an antenna feeder system of a base station in a related technology;

FIG. 1B is a diagram of a structure of an antenna of a base station in a related technology;

FIG. 2A is a diagram of a structure of an antenna according to some embodiments of this application;

FIG. 2B is a diagram of a cross-sectional structure of an antenna at A-A in FIG. 2A according to some embodiments of this application;

FIG. 2C is a diagram of a cross-sectional structure of an antenna at A-A in FIG. 2A according to some embodiments of this application;

FIG. 3A is a diagram of an enlarged structure of an antenna at B in FIG. 2B according to some embodiments of this application;

FIG. 3B is a diagram of an enlarged structure of an antenna at B in FIG. 2B according to some embodiments of this application;

FIG. 3C is a diagram of an enlarged structure of an antenna at B in FIG. 2B according to some embodiments of this application;

FIG. 3D is a diagram of an enlarged structure of an antenna at B in FIG. 2B according to some embodiments of this application;

FIG. 3E is a diagram of an enlarged structure of an antenna at B in FIG. 2B according to some embodiments of this application;

FIG. 4A is a diagram of an enlarged structure of an antenna at B in FIG. 2B according to some embodiments of this application;

FIG. 4B is a diagram of an enlarged structure of an antenna at C in FIG. 2C according to some embodiments of this application;

FIG. 4C is a diagram of an enlarged structure of an antenna at B in FIG. 2B according to some embodiments of this application;

FIG. 4D is a diagram of an enlarged structure of an antenna at C in FIG. 2C according to some embodiments of this application;

FIG. 5 is a diagram of an enlarged structure of an antenna at B in FIG. 2B according to some embodiments of this application;

FIG. 6 is a diagram of a cross-sectional structure of an antenna at A-A in FIG. 2A according to some embodiments of this application;

FIG. 7A is a diagram of a structure of a phase shifter according to some embodiments of this application;

FIG. 7B is a diagram of a structure of an antenna according to some embodiments of this application;

FIG. 7C is a diagram of a connection structure between an input/output main line of a phase shifter and a flat transmission line according to some embodiments of this application;

FIG. 7D is a diagram of a connection structure between an input/output main line of a phase shifter and a flat transmission line according to some embodiments of this application;

FIG. 7E is a diagram of a structure of an antenna according to some embodiments of this application;

FIG. 7F is a diagram of a connection structure between an input/output main line of a phase shifter and a flat transmission line according to some embodiments of this application;

FIG. 8 is a diagram of a structure of an antenna according to some embodiments of this application;

FIG. 9 is a diagram of a structure of an antenna according to some embodiments of this application;

FIG. 10 is a diagram of a structure of an antenna according to some embodiments of this application;

FIG. 11 is a diagram of a structure of an antenna according to some embodiments of this application;

FIG. 12A is a diagram of a structure of an antenna according to some embodiments of this application; and

FIG. 12B is a diagram of a cross-sectional structure of an antenna at E-E in FIG. 12A according to some embodiments of this application.

### REFERENCE NUMERALS

### Related Technology:

100: antenna feeder system; 10: mounting pole; 11: antenna; 12: antenna adjustment bracket; 13: feeder; 14: joint sealing member; 15: grounding apparatus;
111: radome; 112: end cover; 113: connector; 114: reflection plate; 115: radiating element array; 1150: radiating element; and
116: feeding network; 117: transmission module; 160: main feeder; 161: phase shifter; 1610: phase shift component.
   In Embodiments of this Application:
21: antenna; 214: reflection plate; 215: radiating element array; 2150: radiating element; 41: first surface; 42: second surface; 212: end cover;
213: connector; 216: feeding network; 217: transmission module; 261: phase shifter; 2620: external conductor cavity; 2630: phase shift circuit;
2631: input/output main line; 201: sub-cavity; 202: metal plate; 203: spacing structure; 204: bridge; 2611: first portion;
2612: second portion; 2640: phase shift component; 260: flat transmission line; 61: strip line; 62: microstrip line; 63: coplanar waveguide;
650: signal transmission strip line; 651: ground plane; 652: air gap; 60: insulating medium; 6511: ground plate;
6512a and 6512b: first wide side surfaces; 6513a and 6513b: second wide side surfaces; 6514a and 6514b: first narrow side surfaces;
6515aand 6515b: second narrow side surfaces; 6516: strip-shaped opening; 606: insulating support structure; 607: insulating line clamp; 262: flexible cable;
263: function extension component; 601: first extension section; 602: second extension section; 603: third extension section; D1: longitudinal direction of the reflection plate;
D2: width direction of the flat transmission line; D3: thickness direction of the flat transmission line; and D4: width direction of the phase shifter.

### Description of Embodiments

To make the objectives, technical solutions, and advantages of this application clearer, the following further describes this application in detail with reference to the accompanying drawings.

Terms used in the following embodiments are merely intended to describe specific embodiments, but are not intended to limit this application. As used in the specification and appended claims of this application, the terms “one”, “a”, “the”, “the foregoing”, “this”, and “this one” in singular forms are intended to also include expressions such as “one or more”, unless otherwise indicated in the context explicitly.

Reference to “an embodiment” or “a specific embodiment” or the like described in the specification means that one or more embodiments of this application include a specific feature, structure, or characteristic described with reference to this embodiment. The terms “include”, “comprise”, “have” and their variants all mean “include but are not limited to”, unless otherwise specifically emphasized in another manner.

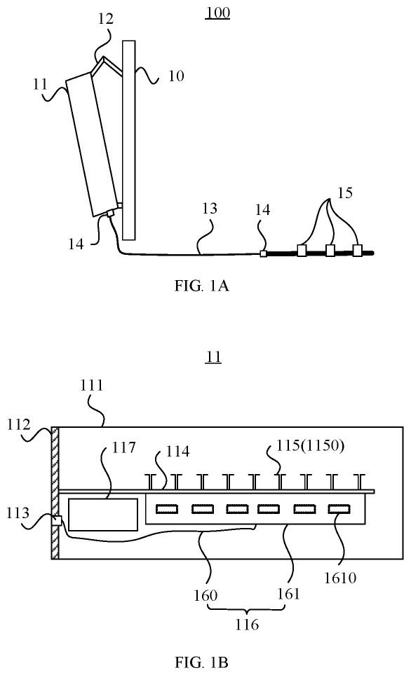

In mobile communication technologies, a base station belongs to an access network device and is configured to provide a wireless coverage function. Specifically, the base station may provide radio signal coverage through an antenna feeder system including at least one antenna, and may receive, send, or transmit a radio signal through the antenna feeder system. Therefore, the antenna feeder system is an important device for the base station to transmit a radio frequency signal and transmit and receive an electromagnetic wave. In a related technology, as shown in FIG. 1A, an antenna feeder system 100 generally includes a mounting pole 10, an antenna 11, an antenna adjustment bracket 12, a feeder 13, some joint sealing members 14, a grounding apparatus 15, and the like. The antenna 11 may be mounted on the mounting pole 10 through the antenna adjustment bracket 12, and a position or an angle of the antenna 11 relative to the mounting pole 10 may be adjusted through the antenna adjustment bracket 12. The antenna 11 may be connected to the feeder 13 through the joint sealing member 14, and the feeder 13 may be connected to the grounding apparatus 15 through another joint sealing member 14.

As shown in FIG. 1B, in a related technology, a main structure of the antenna 11 includes a radome 111, an end cover 112, a connector 113 disposed on the end cover 112, and a reflection plate 114, a radiating element array 115, a feeding network 116, and a transmission module 117 that are disposed in the radome 111. The connector 113 is used as a radio frequency interface of the antenna 11 and configured to externally connect to, for example, the feeder 13 of the antenna feeder system 100 shown in FIG. 1A (in this specification, a “connection” between two electrical structures may be understood as an “electrical connection”). The radiating element array 115 includes a plurality of radiating elements 1150. The radiating element 1150 is also referred to as an antenna element and configured to radiate or receive a radio wave. The plurality of radiating elements 1150 are disposed on the reflection plate 114. Specifically, the plurality of radiating elements 1150 are arranged in an array on the reflection plate 114. The feeding network 116 is connected to the connector 113 and the radiating element array 115, and forms a transmission path for a radio frequency signal (referred to as a signal) between the connector 113 and the radiating element array 115, and is configured to implement functions such as impedance matching, amplitude adjustment, and phase adjustment of the signal. The feeding network 116 generally includes a phase shifter 161 and a transmission line (FIG. 1B only shows a portion of the transmission line between the connector 113 and the phase shifter 161, for example, a main feeder 160 described below, and other portions of the transmission line are not shown in the figure), and may further include function extension components such as a combiner and a filter (not shown in FIG. 1B). The portion of the transmission line between the connector 113 and the phase shifter 161 in the feeding network 116 is generally referred to as the main feeder 160 of the antenna. Based on a different specific design of the antenna 11, the main feeder 160 may include one or more transmission line sections. The transmission module 117 is configured to drive a phase shift component 1610 in the phase shifter 161 to move, so as to adjust an electrical downtilt of the radiating element 1150. The reflection plate 114 is also referred to as a bottom plate, an antenna panel, a metal reflective surface, or the like, may enhance performance of the antenna 11 by reflecting a signal, and enhance a gain and directivity of the antenna 11, so that signal receiving and sending are more sensitive, stable, and reliable. The reflection plate 114 has a shielding effect on an interference signal, and may be further used as a mounting carrier. For example, the radiating element array 115, the feeding network 116, and the transmission module 117 may all be mounted on the reflection plate 114.

Because the main feeder 160 causes attenuation to a signal while transmitting the signal, how to reduce a loss caused by the main feeder 160 to the transmitted signal to improve energy efficiency of the antenna 11 is an important aspect in research and development by a person skilled in the art. In addition, a structure of the feeding network 116 is usually complex (FIG. 1B is merely a simplified example), and occupies large space. Therefore, how to optimize the structure of the feeding network 116 to improve structural compactness of the antenna 11 is also an important aspect considered by a person skilled in the art.

In this application, energy efficiency may be understood as a ratio of output useful energy to input energy, and reflects a level of energy utilization efficiency. For a cable, a transmission loss of the cable is usually related to a cross-sectional area and a length of the cable, a material and a volume proportion of an insulating medium, and the like of the cable. In some related technologies, the main feeder 160 of the feeding network 116 uses a conventional round cable. Due to a limitation of a cross-sectional shape of the conventional round cable, to facilitate bending and routing, a round cable with a thin diameter and a small cross-sectional area is usually used. Because a transmission loss of the cable is inversely proportional to the cross-sectional area of the cable, using such a round cable as the main feeder 160 causes a large transmission loss. In addition, in a structure of the round cable, a volume proportion of an insulating medium is usually large. This also causes signal attenuation, thereby increasing the transmission loss of the cable. In addition, in the related technology, there is no targeted routing layout design for the main feeder 160. Consequently, cables occupy much space in the antenna 11, and are disordered and untidy. This may also cause an increase in the transmission loss.

In view of this, embodiments of this application provide an antenna, a phase shifter, and a base station, to improve energy efficiency of the antenna and compactness of a structure of the antenna. The following describes embodiments of this application in detail with reference to the accompanying drawings.

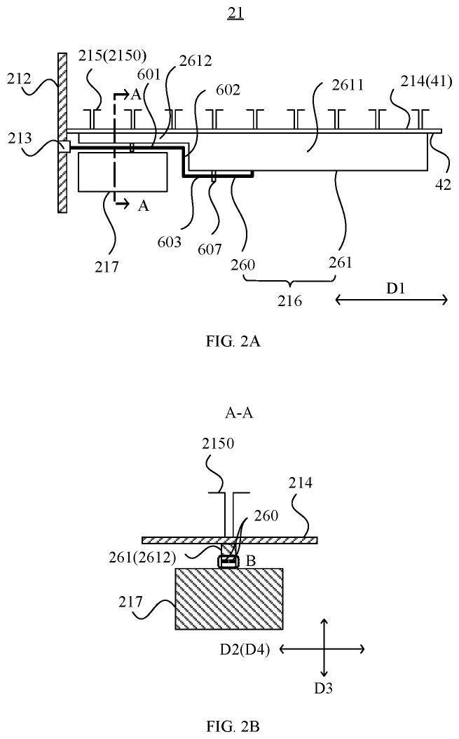

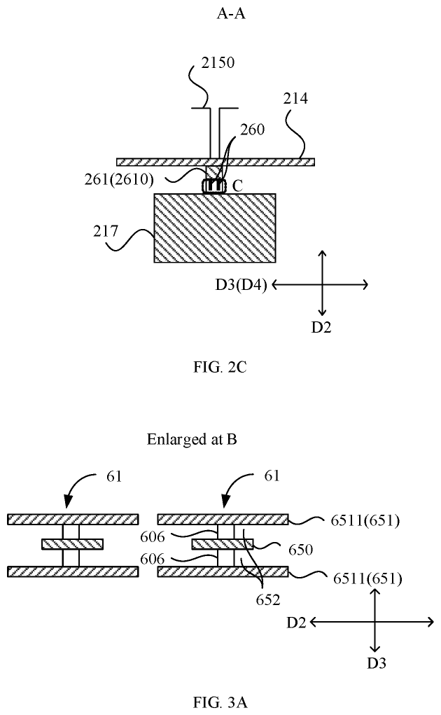

FIG. 2A is a diagram of a structure of an antenna 21 according to some embodiments of this application. A main structure of the antenna 21 includes a reflection plate 214, a radiating element array 215, an end cover 212, a connector 213, a feeding network 216, and a transmission module 217. The reflection plate 214 includes a first surface 41 and a second surface 42, and the radiating element array 215 is disposed on the first surface 41 of the reflection plate 214. The end cover 212 is disposed at an end of the reflection plate 214 in a longitudinal direction D1, and the connector 213 is disposed on the end cover 212. The feeding network 216 is separately connected to the connector 213 and the radiating element array 215. The feeding network 216 includes a phase shifter 261 and a transmission line (only a flat transmission line 260 that is a portion of the transmission line is shown in the figure), where the transmission line includes the flat transmission line 260 used to transmit a signal between the connector 213 and the phase shifter 261. The transmission module 217 is disposed on the second surface 42 of the reflection plate 214 and adjacent to the end cover 212. The transmission module 217 is configured to drive the phase shifter 261 to execute a phase shift. A portion of the flat transmission line 260 is located between the transmission module 217 and the reflection plate 214.

As shown in FIG. 2A, the longitudinal direction D1 of the reflection plate 214 may be understood as an extension direction of a length of the reflection plate 214. The reflection plate 214 may be in a flat plate shape shown in FIG. 2A, or may be in another non-flat plate shape, for example, a U-shaped plate shape. In this embodiment, the phase shifter 261 is disposed on the second surface 42 of the reflection plate 214. In another embodiment of this application, the phase shifter 261 may alternatively be disposed on the first surface 41 of the reflection plate 214. The antenna 21 may further include a radome (not shown in FIG. 2A), and the radome and the end cover 212 may jointly form an accommodating cavity configured to accommodate the reflection plate 214, the radiating element array 215, the feeding network 216, the transmission module 217, and the like.

As described above, the entire transmission line that is in the feeding network 216 and located between the connector 213 and the phase shifter 261 is referred to as a main feeder of the antenna 21. The flat transmission line 260 is configured to transmit a signal between the connector 213 and the phase shifter 261. In other words, the flat transmission line 260 may be used as the main feeder or as a portion of the main feeder.

For example, in some embodiments, one end of the flat transmission line 260 is directly connected to the connector 213, and the other end of the flat transmission line 260 is directly connected to the phase shifter 261. In this way, the flat transmission line 260 may be used as the main feeder.

For example, in some embodiments, an end of the flat transmission line 260 away from the phase shifter 261 is indirectly connected to the connector 213. For example, optionally, the end of the flat transmission line 260 away from the phase shifter 261 is connected to an intermediary component like a combiner or a filter, and the intermediary component like the combiner or the filter is connected to the connector 213. In addition/Alternatively, an end of the flat transmission line 260 away from the connector 213 is indirectly connected to the phase shifter 261. For example, optionally, the end of the flat transmission line 260 away from the connector 213 is connected to an intermediary component like a combiner or a filter, and the intermediary component like the combiner or the filter is connected to the phase shifter 261. In these embodiments, the flat transmission line 260 may be used as a portion of the main feeder. In this case, the main feeder may further include another transmission line of a same or different type.

For example, in some embodiments, an end of the flat transmission line 260 away from the connector 213 may further extend into the phase shifter 261, and is connected to an input/output main line of a phase shift circuit of the phase shifter 261.

In this embodiment of this application, a portion of the flat transmission line 260 is located between the transmission module 217 and the reflection plate 214. In other words, the portion of the flat transmission line 260 is routed between the transmission module 217 and the reflection plate 214. An end of the flat transmission line 260 away from the phase shifter 261 may be located in a gap between the transmission module 217 and the reflection plate 214, or may extend out of the gap between the transmission module 217 and the reflection plate 214 in the longitudinal direction D1 shown in the figure. In this way, the terminal device is closer to the end cover 212.

FIG. 2B is a diagram of a cross-sectional structure of the antenna at A-A in FIG. 2A according to some embodiments of this application. A width direction D2 of the flat transmission line 260 is parallel to the reflection plate 214, and a thickness direction D3 of the flat transmission line 260 is orthogonal to the reflection plate 214. In this specification, parallelism may be understood as parallelism within a specific error range, and orthogonality may be understood as orthogonality within a specific error range. In this embodiment of this application, an arrangement manner of the flat transmission line 260 is not limited to that shown in FIG. 2B. In some embodiments, as shown in FIG. 2C, the width direction D2 of the flat transmission line 260 may alternatively be orthogonal to the reflection plate 214. In this case, the thickness direction D3 of the flat transmission line 260 is parallel to the reflection plate 214.

It can be learned from FIG. 2B and FIG. 2C that a size in the width direction D2 of the flat transmission line 260 is definitely greater than a size in the thickness direction D3 of the flat transmission line 260. Therefore, the flat transmission line 260 is approximately flat. The flat transmission line 260 has advantages such as light weight, a small size, convenient routing, a wide frequency band, high reliability, a low transmission loss, low costs, and a long service life. Compared with a related technology, the antenna 21 according to the foregoing embodiment of this application has at least the following technical advantages.

Compared with a conventional round cable, the flat transmission line 260 is more easily bent and routed. A cross-sectional area of the flat transmission line 260 may be designed to be larger, and a volume proportion of an insulating medium in a structure of the flat transmission line 260 may be designed to be smaller. Therefore, when the flat transmission line 260 is used in the antenna 21, a transmission loss of a main feeder can be reduced, and energy efficiency of the antenna 21 is improved.

Because a portion of the flat transmission line 260 is located between the transmission module 217 and the reflection plate 214, that is, the flat transmission line 260 is routed between the transmission module 217 and the reflection plate 214, the flat transmission line 260 may be disposed through a gap between the transmission module 217 and the reflection plate 214, so that an internal structure of the antenna 21 is more compact and tidier.

In some embodiments of this application, the antenna 21 may use a single-frequency design. For example, a plurality of radiating elements 2150 in the radiating element array 215 have a same operating frequency band. In some other embodiments of this application, the antenna 21 may alternatively use a multi-frequency design. For example, a plurality of radiating elements 2150 in the radiating element array 215 are divided into at least two groups, and different groups have different operating frequency bands. When the antenna 21 uses a multi-frequency design, a structural design of the feeding network 216 is more complex due to an increase in frequency bands. In this case, in this embodiment of this application, the flat transmission line 260 is used as a main feeder or a portion of the main feeder, and a portion of the flat transmission line 260 is routed between the transmission module 217 and the reflection plate 214, so that space utilization inside the antenna 21 can be improved, and a structure is compact. This helps reduce a volume of the antenna 21.

As shown in FIG. 2B and FIG. 2C, in some embodiments of this application, the transmission line may include at least two flat transmission lines 260 that extend in parallel and are configured to transmit signals in different polarization directions, for example, two flat transmission lines 260 shown in the figure.

A direction of electric field strength formed during antenna radiation is referred to as a polarization direction of the antenna. When the antenna includes at least two polarization directions, signals in different polarization directions need to be transmitted through different flat transmission lines 260. For example, in some embodiments, the antenna 21 is a dual-polarized antenna, and includes two polarization directions: +45° and −45°. The transmission line includes two flat transmission lines 260 that extend in parallel. One flat transmission line 260 is configured to transmit a signal in the polarization direction of +45°, and the other flat transmission line 260 is configured to transmit a signal in the polarization direction of −45°. This embodiment of this application supports a multi-polarization design of the antenna 21, so that the antenna 21 has higher signal sending and receiving efficiency. In another embodiment of this application, if the antenna 21 uses a single-polarization design, one flat transmission line 260 may alternatively be used.

In some embodiments of this application, as shown in FIG. 2A, the flat transmission line 260 may be fastened to at least one of the reflection plate 214, the transmission module 217, the phase shifter 261, or the like through a connecting piece like an insulating line clamp 607. In some other embodiments of this application, the flat transmission line 260 includes a plurality of insulating mounting parts (not shown in FIG. 2A), and the plurality of insulating mounting parts are fastened to at least one of the reflection plate 214, the transmission module 217, the phase shifter 261, or the like. For example, the plurality of insulating mounting parts may be protrusions protruding from a surface of the flat transmission line 260, and are fastened to at least one of the reflection plate 214, the transmission module 217, the phase shifter 261, or the like through a fastener or an adhesive. In these embodiments, the flat transmission line 260 can be reliably and easily mounted, and the flat transmission line 260 can be easily and precisely routed.

In this embodiment of this application, a structure of the flat transmission line 260 includes a signal transmission strip line and a ground plane that is spaced apart from the signal transmission strip line. The signal transmission strip line is configured to transmit a signal, and the ground plane is used as a ground reference plane and configured to ground the signal transmission strip line and provide shielding protection for the signal transmission strip line. An insulating medium may be filled between the signal transmission strip line and the ground plane, or an air gap may be designed between the signal transmission strip line and the ground plane. When the air gap is designed between the signal transmission strip line and the ground plane, a volume of the insulating medium in the structure of the flat transmission line 260 is small, so that a signal transmission loss can be reduced.

In some embodiments of this application, a width direction of the signal transmission strip line is also the width direction D2 of the flat transmission line 260, and may be set to be parallel to the reflection plate 214. In some other embodiments of this application, a thickness direction of the signal transmission strip line is also the thickness direction D3 of the flat transmission line 260, and may also be set to be parallel to the reflection plate 214.

A specific type and structure of the flat transmission line 260 are not limited in embodiments of this application. The flat transmission line 260 may be any one of a strip line (strip line), a microstrip line (microstrip line), a coplanar waveguide (coplanar waveguide, CPW), or the like. The following describes some optional types of the flat transmission line 260 through examples.

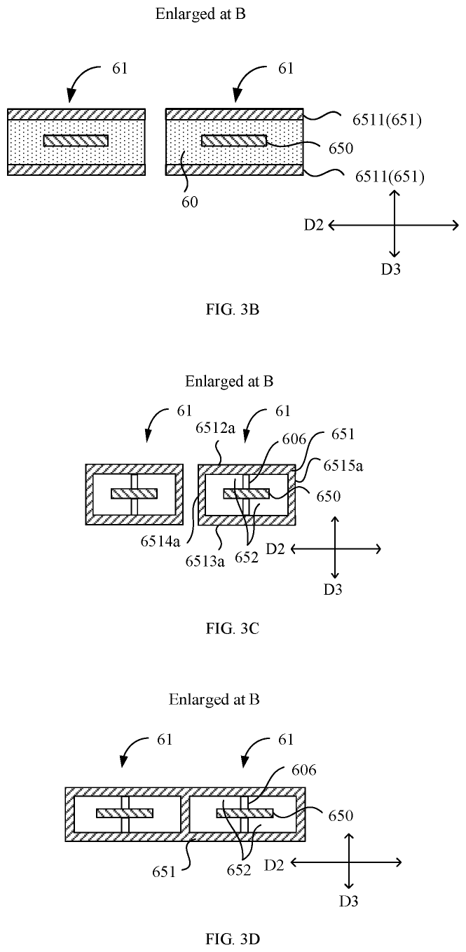

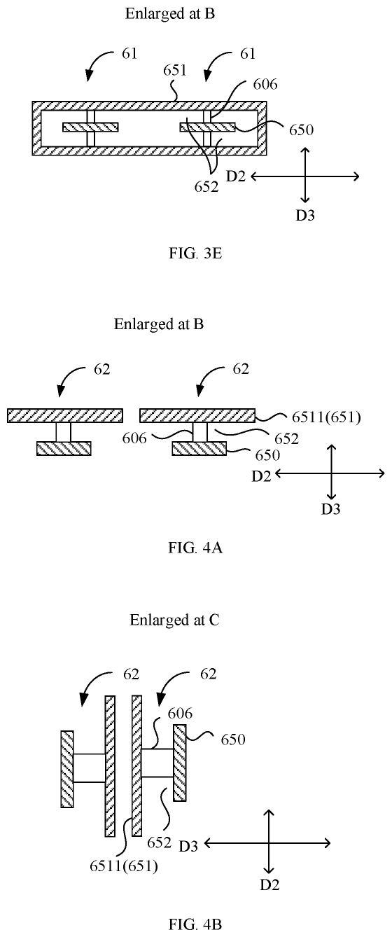

With reference to FIG. 2B and FIG. 3A, in some embodiments, the flat transmission line 260 uses a strip line 61, and a ground plane 651 of the flat transmission line 260 includes two ground plates 6511 that are disposed parallel to a signal transmission strip line 650. The signal transmission strip line 650 is located between the two ground plates 6511, and the signal transmission strip line 650 is spaced apart from the two ground plates 6511 by a plurality of insulating support structures 606. An air gap 652 is separately provided between the signal transmission strip line 650 and the two ground plates 6511. In this embodiment, a width direction (which is also the width direction D2 of the flat transmission line 260) of the signal transmission strip line 650 is parallel to the reflection plate 214. In another embodiment, a thickness direction (which is also the thickness direction D3 of the flat transmission line 260) of the signal transmission strip line 650 may also be set to be parallel to the reflection plate 214. In some embodiments, a surface of the signal transmission strip line 650 may be exposed to the air gaps 652 on both sides. In some other embodiments, a surface of the signal transmission strip line 650 may alternatively be covered with a layer of dielectric film (not shown in the figure), for example, a green oil anti-corrosion film. In this way, the surface of the signal transmission strip line 650 is not directly exposed to the air gap 652.

With reference to FIG. 2B and FIG. 3B, in some embodiments, the flat transmission line 260 uses a strip line 61, and a ground plane 651 of the flat transmission line 260 includes two ground plates 6511 that are disposed parallel to the signal transmission strip line 650. The signal transmission strip line 650 is located between the two ground plates 6511, and an insulating medium 60 is filled between the signal transmission strip line 650 and the two ground plates 6511. In this embodiment, a width direction (which is also the width direction D2 of the flat transmission line 260) of the signal transmission strip line 650 is parallel to the reflection plate 214. In another embodiment, a thickness direction (which is also the thickness direction D3 of the flat transmission line 260) of the signal transmission strip line 650 may also be set to be parallel to the reflection plate 214. In these embodiments, the insulating support structure 606 may be disposed or not disposed according to a design requirement.

The strip line 61 has advantages such as a small size, a light weight, a wide frequency band, a high Q value (a quality factor, a quality factor, and a higher Q value indicates a smaller transmission loss), a simple process, and low costs. The strip line 61 is used as the flat transmission line 260 in this embodiment of this application, so that a transmission loss of the main feeder can be reduced, and routing is convenient. When the strip line 61 is designed to have a structure with an air gap 652, a volume of an insulating medium in the structure of the strip line 61 accounts for a small proportion, so that the transmission loss of the main feeder can be further reduced.

With reference to FIG. 2B and FIG. 3C, in some embodiments, the flat transmission line 260 is a strip line 61, and a ground plane 651 of the flat transmission line 260 includes a first wide side surface 6512a and a second wide side surface 6513a that are disposed in parallel, and a first narrow side surface 6514a and a second narrow side surface 6515a that are disposed in parallel. The first wide side surface 6512a, the second wide side surface 6513a, the first narrow side surface 6514a, and the second narrow side surface 6515a form a rectangular cavity. The signal transmission strip line 650 is located in the rectangular cavity and disposed parallel to the first wide side surface 6512a and the second wide side surface 6513a, and an air gap 652 is provided in the rectangular cavity. This embodiment may be considered as a deformed structure of the strip line 61 shown in FIG. 3A. In this embodiment, the rectangular cavity formed by the first wide side surface 6512a, the second wide side surface 6513a, the first narrow side surface 6514a, and the second narrow side surface 6515a may provide a better shielding protection effect for the signal transmission strip line 650, thereby helping improve signal transmission stability. In some other embodiments, the rectangular cavity may also be filled with an insulating medium.

In some embodiments, when the transmission line includes at least two flat transmission lines 260 that extend in parallel and are configured to transmit signals in different polarization directions (for example, two flat transmission lines 260 shown in FIG. 2B), ground planes of the at least two flat transmission lines 260 may be designed to be integrally connected to each other. With reference to FIG. 2B and FIG. 3D, in this embodiment, the flat transmission line 260 is a strip line 61, ground planes 651 of two strip lines 61 are integrally connected and form two rectangular cavities, and signal transmission strip lines 650 of the two strip lines 61 are respectively located in the two rectangular cavities. This embodiment may be considered as a deformed structure of the strip line 61 shown in FIG. 3C. With reference to FIG. 2B and FIG. 3E, in this embodiment, the flat transmission line 260 is a strip line 61, ground planes 651 of two strip lines 61 are integrally connected and form a rectangular cavity, and signal transmission strip lines 650 of the two strip lines 61 are located in the rectangular cavity and are spaced apart from each other. This embodiment may also be considered as a deformed structure of the strip line 61 shown in FIG. 3C. Designs of these embodiments can not only provide a good shielding protection effect for the signal transmission strip line 650, but also help reduce a size occupied by the flat transmission line 260 in a width direction and reduce a weight of the flat transmission line 260.

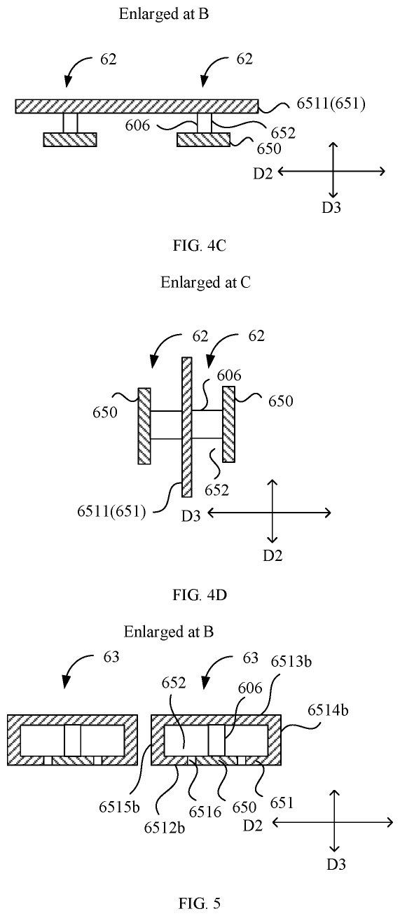

With reference to FIG. 2B and FIG. 4A, in some embodiments, the flat transmission line 260 uses a microstrip line 62, and a ground plane 651 of the flat transmission line 260 includes one ground plate 6511 disposed parallel to the signal transmission strip line 650. The signal transmission strip line 650 and the one ground plate 6511 are spaced apart by a plurality of insulating support structures 606, and an air gap 652 is provided between the signal transmission strip line 650 and the one ground plate 6511. In this embodiment, a width direction (which is also the width direction D2 of the flat transmission line 260) of the signal transmission strip line 650 is parallel to the reflection plate 214. In addition, signal transmission strip lines 650 of two microstrip lines 62 are respectively located, in a one-to-one correspondence, on sides that are of ground plate 6511 of the two microstrip lines 62 and away from the reflection plate 214. In another embodiment, as shown in FIG. 2C and FIG. 4B, a thickness direction (which is also the thickness direction D3 of the flat transmission line 260) of the signal transmission strip line 650 may alternatively be set to be parallel to the reflection plate 214, and signal transmission strip lines 650 of two microstrip lines 62 are away from each other. In some embodiments, a surface of the signal transmission strip line 650 may be exposed to an air gap 652 and air on the other side. In some other embodiments, a surface of the signal transmission strip line 650 may alternatively be covered with a layer of dielectric film (not shown in the figure), for example, a green oil anti-corrosion film. In this way, the surface of the signal transmission strip line 650 is not directly exposed to the air gap 652 and air on the other side.

In some embodiments, the microstrip line 62 may not use the foregoing design including the air gap structure, but instead, an insulating medium is filled between the one ground plate 6511 and one signal transmission strip line 650. In these embodiments, the insulating support structure 606 may be disposed or not disposed.

The microstrip line 62 has advantages such as a small size, a light weight, a wide frequency band, high reliability, and low preparation costs. In addition, the microstrip line 62 has a good anti-electromagnetic interference capability, a high characteristic impedance, and a higher transmission rate. The microstrip line 62 is used as the flat transmission line 260 in this embodiment of this application, so that a transmission loss of the main feeder can be reduced, and routing is convenient. When the microstrip line 62 is designed to have a structure with an air gap 652, a volume of an insulating medium in the structure of the microstrip line 62 accounts for a small proportion, so that the transmission loss of the main feeder can be further reduced.

With reference to FIG. 2B and FIG. 4C, in some embodiments, when the transmission line includes at least two microstrip lines 62 that extend in parallel and are configured to transmit signals in different polarization directions, ground plates 6511 of the at least two microstrip lines 62 may be designed to be integrally connected to each other. In this embodiment, when the width direction D2 of the flat transmission line 260 is parallel to the reflection plate 214, the ground plates 6511 of the two microstrip lines 62 may be coplanar and integrally connected to each other. With reference to FIG. 2C and FIG. 4D, in some other embodiments, when the thickness direction D3 of the flat transmission line 260 is parallel to the reflection plate 214, two microstrip lines 62 may share a same ground plate 6511, and the two microstrip lines 62 are respectively located on two sides of the ground plate 6511.

With reference to FIG. 2B and FIG. 5, in some embodiments, the flat transmission line 260 uses a coplanar waveguide 63, and a ground plane 651 of the flat transmission line 260 includes a first wide side surface 6512b and a second wide side surface 6513b that are disposed in parallel, and a first narrow side surface 6514b and a second narrow side surface 6515b that are disposed in parallel. The first wide side surface 6512b, the second wide side surface 6513b, the first narrow side surface 6514b, and the second narrow side surface 6515b form a rectangular cavity, and an air gap 652 is provided in the rectangular cavity. The first wide side surface 6512b has a strip-shaped opening 6516, the signal transmission strip line 650 is located in the strip-shaped opening 6516, and the signal transmission strip line 650 and the second wide side surface 6513b are spaced apart by a plurality of insulating support structures 606. In this embodiment, a width direction (which is also the width direction D2 of the flat transmission line 260) of the signal transmission strip line 650 is parallel to the reflection plate 214. In another embodiment, a thickness direction (which is also the thickness direction D3 of the flat transmission line 260) of the signal transmission strip line 650 may also be set to be parallel to the reflection plate 214. In some embodiments, a surface of the signal transmission strip line 650 may be exposed to an air gap 652 and air on the other side. In some other embodiments, a surface of the signal transmission strip line 650 may alternatively be covered with a layer of dielectric film (not shown in the figure), for example, a green oil anti-corrosion film. In this way, the surface of the signal transmission strip line 650 is not directly exposed to the air gap 652 and air on the other side.

In some implementations, the coplanar waveguide 63 may not use the foregoing design including the air gap structure, but instead, an insulating medium is filled in the rectangular cavity. In these embodiments, the insulating support structure 606 may be disposed or not disposed.

In some embodiments, when the transmission line includes at least two coplanar waveguides 63 that extend in parallel and are configured to transmit signals in different polarization directions, ground planes 651 of the at least two coplanar waveguides 63 may be designed to be integrally connected to each other. For example, side surfaces that are of the two coplanar waveguides 63 in the embodiment shown in FIG. 5 and close to each other may be designed to be integrally connected to each other, and the two coplanar waveguides 63 share one side surface. More variant design solutions are not listed herein one by one.

The coplanar waveguide 63 has advantages such as a small size, a light weight, and ease of linear polarization, circular polarization, dual polarization, and multi-band operation. In addition, the coplanar waveguide 63 has a better shielding effect, and therefore is conducive to implementing a thinner and lighter size design. The coplanar waveguide 63 is used as the flat transmission line 260 in this embodiment of this application, so that a transmission loss of the main feeder can be reduced, and routing is convenient. When the coplanar waveguide 63 is designed to have a structure with an air gap 652, a volume of an insulating medium in the structure of the coplanar waveguide 63 accounts for a small proportion, so that the transmission loss of the main feeder can be further reduced.

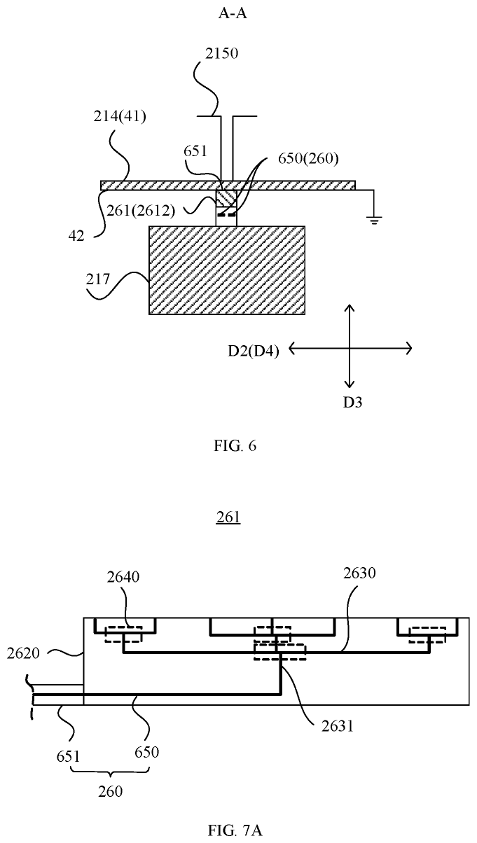

In some embodiments of this application, as shown in FIG. 6, the reflection plate 214 is grounded, a width direction (which is also the width direction D2 of the flat transmission line 260) of the signal transmission strip line 650 of the flat transmission line 260 is parallel to the reflection plate 214, and at least a portion of the ground plane 651 of the flat transmission line 260 may be integrated into the reflection plate 214. Because the reflection plate 214 is usually made of a metal material, in some embodiments, the reflection plate 214 may be grounded, so that the reflection plate 214 may be used as the ground plane 651 of the flat transmission line 260. In some other embodiments, at least a portion of the ground plane 651 of the flat transmission line 260 may alternatively be prepared on the reflection plate 214 that is grounded. Deigns of these embodiments can simplify the structure of the flat transmission line 260, make processing and preparation of the flat transmission line 260 easier, and make routing and layout easier. In this embodiment, the flat transmission line 260 may be any one of the strip line 61, the microstrip line 62, and the coplanar waveguide 63.

The foregoing embodiment describes only some structural design forms of the flat transmission line 260. Based on the foregoing structural design, a specific structural form of the flat transmission line 260 may be appropriately designed and changed, and is not limited to that shown in the figure.

A phase shifter is an electronic component used to change a signal phase, and may delay or advance a phase of an input signal by a specific angle, thereby adjusting the phase of the signal. In an antenna, the phase shifter is usually used to adjust a phase difference between radiating elements, so as to implement beamforming and direction control of a radiating element array. A working principle of the phase shifter may be implemented in a plurality of manners. For example, a phase change may be implemented by changing a physical length of a signal transmission line. Such a phase shifter is, for example, a sector-shaped or arc-shaped sliding piece phase shifter, or a u-shaped sliding piece phase shifter. In addition, a phase change may be implemented by changing an equivalent dielectric constant of signal transmission space. Such a phase shifter is, for example, a dielectric sliding phase shifter. A type of the phase shifter 261 is not specifically limited in embodiments of this application. For example, the phase shifter 261 may be selected from one of a sector-shaped or arc-shaped sliding piece phase shifter, a u-shaped sliding piece phase shifter, or a dielectric sliding phase shifter.

In some embodiments of this application, for example, as shown in FIG. 2A, the flat transmission line 260 may be routed outside the phase shifter 261, and the routing manner is simple, intuitive, and easy to operate.

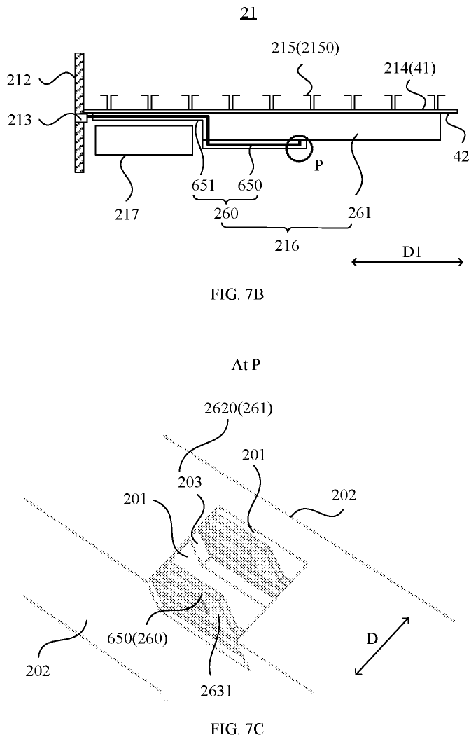

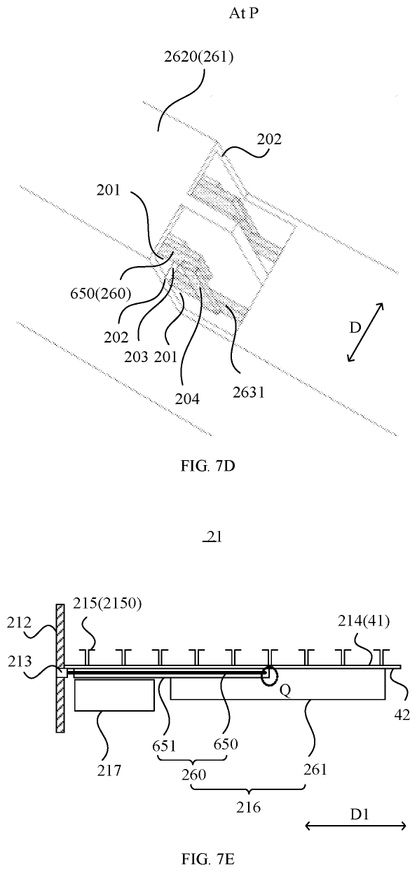

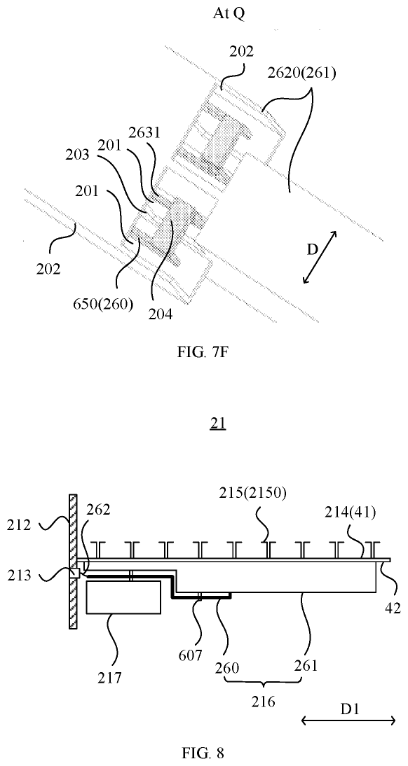

FIG. 7A is a simplified diagram of a structure of a phase shifter 261 according to some embodiments of this application. In these embodiments, a part or all of the signal transmission strip line 650 of the flat transmission line 260 may be routed inside the phase shifter 261, and the ground plane 651 of the flat transmission line 260 and the phase shifter 261 may be integrated and prepared together. In other words, at least a portion of the flat transmission line 260 is integrated with the phase shifter 261. In this way, not only an internal structure of the antenna 21 can be more compact, but also a routing length of the flat transmission line 260 can be reduced. Because a length of the transmission line is also a factor that affects a transmission loss, at least a portion of the flat transmission line 260 is integrated with the phase shifter 261, to help further reduce the transmission loss of the signal.

As shown in FIG. 7A, in some embodiments, the structure of the phase shifter 261 includes an external conductor cavity 2620 that is grounded, and a phase shift circuit 2630 and a phase shift component 2640 that are disposed in the external conductor cavity 2620 (the phase shift circuit 2630 and the phase shift component 2640 are drawn in a simplified schematic manner, and are not intended to limit an actual structure). The phase shift circuit 2630 includes an input/output main line 2631, the signal transmission strip line 650 of the flat transmission line 260 is connected to the input/output main line 2631, at least a portion of the signal transmission strip line 650 of the flat transmission line 260 extends into the external conductor cavity 2620, and the ground plane 651 of the flat transmission line 260 and the external conductor cavity 2620 are integrally connected to each other. The phase shift component 2640 is configured to be driven by the foregoing transmission module 217 to execute a phase shift. For example, the phase shift component 2640 adjusts a phase of a signal by moving a sliding piece based on the foregoing implementation principle.

In this embodiment, at least one section of the flat transmission line 260 is integrated with the phase shifter 261, and the signal transmission strip line 650 is connected to the input/output main line 2631 inside the phase shifter 261. This can not only reduce a signal transmission loss, but also simplify an internal structure of the antenna 21, so that the internal structure of the antenna 21 is tidier.

In this embodiment of this application, the phase shift circuit 2630 may be prepared through a strip line. The “input/output main line 2631” may be understood as follows: When the foregoing connector 213 transmits a signal to the phase shifter 261 through the flat transmission line 260, the “input/output main line 2631” may be used as an input main line. When the phase shifter 261 transmits a signal to the foregoing connector 213 through the flat transmission line 260, the “input/output main line 2631” may be used as an output main line.

FIG. 7B shows some embodiment solutions in which the flat transmission line 260 and the phase shifter 261 inside the antenna are in integrated design. In this embodiment, the phase shifter 261 may be disposed on the second surface 42 of the reflection plate 214, and the width direction D4 (not shown in the figure due to a viewing angle) of the phase shifter 261 is parallel to the reflection plate 214. The flat transmission line 260 may be approximately in a “Z” shape, and is integrated with the phase shifter 261.

FIG. 7C is a diagram of a connection structure between the input/output main line 2631 of the phase shifter 261 and the flat transmission line 260 at P in FIG. 7B according to some embodiments of this application. The diagram may be understood as an internal three-dimensional structure that can be obtained by observing from a side of the phase shifter 261 away from the reflection plate 214. In order to illustrate the internal structure, the external conductor cavity 2620 of the phase shifter 261 is shown in this figure through partial windowing. In FIG. 7C, there are two flat transmission lines 260, and the two flat transmission lines 260 extend in parallel.

As shown in FIG. 7C, the external conductor cavity 2620 of the phase shifter 261 generally includes two metal plates 202 disposed opposite to each other and a spacing structure 203 located between the two metal plates 202. Space between the two metal plates 202 is divided into a plurality of sub-cavities 201 by the spacing structure 203. Therefore, the external conductor cavity 2620 of the phase shifter 261 includes the plurality of sub-cavities 201. Generally, a distance between the two metal plates 202 is defined as a “cavity height” of the phase shifter 261. The phase shifter 261 may include or not include a housing, and a width direction D4 of the phase shifter 261 is generally consistent with a direction of the “cavity height”. In other words, the width direction of the phase shifter 261 may be understood as a direction orthogonal to the two metal plates 202. In some embodiments, the external conductor cavity 2620 may be integrally formed through profile processing, to form a plurality of sub-cavities 201.

A cavity wall of the sub-cavity 201 may be used as a ground reference plane of the phase shift circuit 2630 and the signal transmission strip line 650 inside the sub-cavity 201, and provide shielding protection for the phase shift circuit 2630 and the signal transmission strip line 650. Both the strip line of the phase shift circuit 2630 and the signal transmission strip line 650 of the flat transmission line 260 may form an equivalent structure of a transmission line like a strip line, a microstrip line, or a coplanar waveguide with the cavity wall of the sub-cavity 201. In some embodiments, an insulating medium may be disposed between the strip line of the phase shift circuit 2630 and the cavity wall of the sub-cavity 201.

In this embodiment of this application, the signal transmission strip line 650 of the flat transmission line 260 and the input/output main line 2631 (namely, the strip line of the phase shift circuit 2630 that is used as the input/output main line 2631) may be welded and integrally connected to each other, may be connected through a bridge 204, or the like, which may be flexibly designed based on a specific routing manner of the signal transmission strip line 650 and the input/output main line 2631. This is not specifically limited in this application. For example, in some embodiments, the signal transmission strip line 650 of the flat transmission line 260 and the input/output main line 2631 may overlap with each other. In this case, the signal transmission strip line 650 of the flat transmission line 260 and the input/output main line 2631 may be connected through laser welding. For example, in some embodiments, the signal transmission strip line 650 of the flat transmission line 260 and the input/output main line 2631 may be integrally connected to each other, without subsequent assembly. For example, in some embodiments, the signal transmission strip line 650 of the flat transmission line 260 and the input/output main line 2631 are spaced from each other. In this case, the signal transmission strip line 650 of the flat transmission line 260 and the input/output main line 2631 may be connected through the bridge 204.

In this embodiment of this application, the input/output main line 2631 and a portion of the signal transmission strip line 650 located in the external conductor cavity 2620 may be located in a same sub-cavity 201 or different sub-cavities 201.

As shown in FIG. 7C, in some embodiments, the input/output main line 2631 and the portion of the signal transmission strip line 650 located in the external conductor cavity 2620 are located in a same sub-cavity 201. In this embodiment, the portion of the signal transmission strip line 650 located in the external conductor cavity 2620 and the input/output main line 2631 may be integrally connected (as shown in the figure), or may be integrally connected through laser welding. In this design, a structure is simplified and processing and preparation are facilitated.

FIG. 7D is a diagram of a connection structure between the input/output main line 2631 of the phase shifter 261 and the flat transmission line 260 at P in FIG. 7B according to some other embodiments of this application. The diagram may be understood as an internal three-dimensional structure that can be obtained by observing from a side of the phase shifter 261 away from the reflection plate 214. To illustrate the internal structure, the external conductor cavity 2620 of the phase shifter 261 is shown in this figure through partial windowing. In FIG. 7D, there are two flat transmission lines 260, and the two flat transmission lines 260 extend in parallel.

In this embodiment, the input/output main line 2631 and the portion of the signal transmission strip line 650 located in the external conductor cavity 2620 are located in different sub-cavities 201. The portion of the signal transmission strip line 650 located in the external conductor cavity 2620 and the input/output main line 2631 may be spaced apart from each other, and may be coplanar or non-coplanar. The input/output main line 2631 and the portion of the signal transmission strip line 650 located in the external conductor cavity 2620 may be connected together through a bridge 204. In this design, a shielding effect of the cavity wall of the sub-cavity 201 can be used to reduce resonance caused when the signal transmission strip line 650 and the input/output main line 2631 transmit a high-frequency signal, thereby improving operating stability of the phase shift circuit 2630. In this embodiment, the phase shifter 261 may be disposed on the second surface 42 of the reflection plate 214, the width direction D4 of the phase shifter 261 is parallel to the reflection plate 214, and the signal transmission strip line 650 is routed on a side of the phase shifter 261 away from the reflection plate.

FIG. 7E shows some other embodiment solutions in which the flat transmission line 260 and the phase shifter 261 inside the antenna are in integrated design. In this embodiment, the phase shifter 261 may be disposed on the second surface 42 of the reflection plate 214, and the width direction D4 (not shown in the figure due to a viewing angle) of the phase shifter 261 is parallel to the reflection plate 214. The flat transmission line 260 may be approximately in a “straight” shape, and is integrated with the phase shifter 261.

FIG. 7F is a diagram of a connection structure between the input/output main line 2631 of the phase shifter 261 and the flat transmission line 260 at Q in FIG. 7E according to some embodiments of this application. The diagram may be understood as an internal three-dimensional structure that can be obtained by observing from a side of the phase shifter 261 away from the reflection plate 214. To illustrate the internal structure, the external conductor cavity 2620 of the phase shifter 261 is shown in this figure through partial windowing. In FIG. 7F, there are two flat transmission lines 260, and the two flat transmission lines 260 extend in parallel.

As shown in FIG. 7F, in some embodiments, the input/output main line 2631 and the portion of the signal transmission strip line 650 located in the external conductor cavity 2620 are located in different sub-cavities 201. In this embodiment, the portion of the signal transmission strip line 650 located in the external conductor cavity 2620 is parallel to the input/output main line 2631. Due to being spaced apart from each other, the input/output main line 2631 and the portion of the signal transmission strip line 650 located in the external conductor cavity 2620 may be connected together through the bridge 204. Similar to the principle of the embodiment shown in FIG. 7D, in this design, a shielding effect of the cavity wall of the sub-cavity 201 can be used to reduce resonance caused when the signal transmission strip line 650 and the input/output main line 2631 transmit a high-frequency signal, thereby improving operating stability of the phase shift circuit 2630. In this embodiment, the phase shifter 261 may be disposed on the second surface 42 of the reflection plate 214, the width direction D4 of the phase shifter 261 is parallel to the reflection plate 214, and the signal transmission strip line 650 is routed on a side portion of the phase shifter 261 orthogonal to the reflection plate 214.

In this embodiment of this application, an end of the flat transmission line 260 away from the phase shifter 261 may be directly connected to the connector 213 (as shown in FIG. 2A), or may be indirectly connected to the connector 213 through another intermediary component (as shown in FIG. 8). For example, the end of the flat transmission line 260 away from the phase shifter 261 and the connector 213 may be connected by welding, by plug-in, by a fastener, or by a flexible cable 262 as shown in FIG. 8. The flat transmission line 260 and the flexible cable 262 may be connected through welding. These connection manners occupy small space and facilitate disassembly and assembly operations.

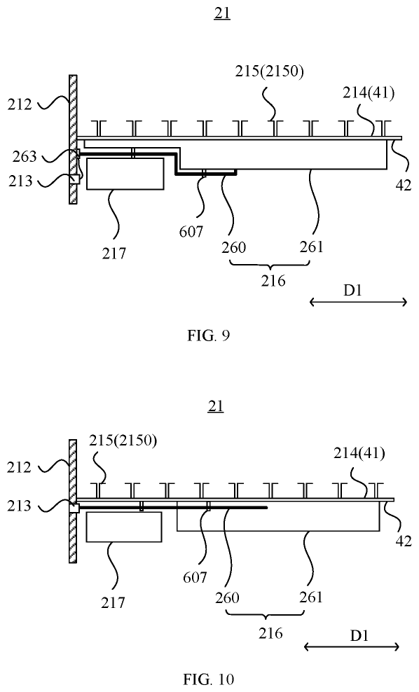

As shown in FIG. 9, in some embodiments of this application, the feeding network 216 further includes a function extension component 263. The function extension component 263 may be disposed on the end cover 212 (as shown in FIG. 9), or may be disposed in spacing space between the end cover 212 and the transmission module 217. The connector 213 and the function extension component 263 are connected, for example, may be connected through a flexible cable, a circuit board, or the like. An end of the flat transmission line 260 away from the phase shifter 261 and the function extension component 263 may be connected by welding, by plug-in, by a fastener, by a flexible cable, or the like.

A specific function type of the function extension component 263 is not limited. For example, the function extension component 263 may be a coupler, a combiner, a splitter, or a filter. There may be one or more function extension components 263. A circuit structure that is of the feeding network 216 and located between the connector 213 and the flat transmission line 260 may be designed according to a product requirement of the antenna 21. A specific structure form of the feeding network 216 is not limited in this application.

In some embodiments of this application, the feeding network 216 may further include a function extension component disposed between the flat transmission line 260 and the phase shifter 261. The function extension component may be, for example, a combiner or a filter, and is not shown in the figure. Based on a definition of the main feeder, a transmission line between the flat transmission line 260 and the function extension component and a transmission line between the function extension component and the phase shifter 261 are also a portion of the main feeder. Therefore, a structural design similar to that of the strip line 61, the microstrip line 62, or the coplanar waveguide 63 may also be used.

In this embodiment of this application, the antenna 21 may include one or more connectors 213. Based on a structural design of the feeding network 216, a quantity of flat transmission lines 260 may be the same as or different from a quantity of connectors 213. For example, two flat transmission lines 260 may be connected to one connector 213, or may be connected to two connectors 213 in a one-to-one correspondence. Details are not listed herein again.

As shown in FIG. 2A, in some embodiments of this application, the transmission module 217 is disposed opposite to one or more radiating elements 2150 that are in the radiating element array 215 and adjacent to the end cover 212. In other words, orthographic projections of the one or more radiating elements 2150 that are in the radiating element array 215 and adjacent to the end cover 212 on the reflection plate 214 fall within an orthographic projection of the transmission module 217 on the reflection plate 214. For example, a first radiating element and a second radiating element that are in the radiating element array 215 and adjacent to the end cover 212 may be disposed opposite to the transmission module 217 on two sides of the reflection plate 214. In this design, compactness of the radiating element array 215 disposed on the reflection plate 214 can be improved, and a multi-frequency design of the antenna 21 is facilitated.

Still refer to FIG. 2A. In some embodiments of this application, an end of the flat transmission line 260 away from the phase shifter 261 extends in the longitudinal direction D1 to a position between the end cover 212 and the first radiating element 2150 adjacent to the end cover 212. In this design, the end of the flat transmission line 260 away from the phase shifter 261 may be as close as possible to the end cover 212, so that connection and assembly between the flat transmission line 260 and components such as the connector 213 are easier. In addition, a line length proportion of the flat transmission line 260 in the main feeder can be increased as much as possible, thereby further reducing a transmission loss.

In some embodiments of this application, the end of the flat transmission line 260 away from the phase shifter 261 may alternatively extend, in the longitudinal direction D1, between the first radiating element and the second radiating element that are adjacent to the end cover 212. It is also basically convenient to connect and assemble the flat transmission line 260 to components such as the connector 213. In addition, the flat transmission line 260 also has a sufficient line length.

In this embodiment of this application, a specific routing shape of the flat transmission line 260 is not limited. For example, the flat transmission line 260 may extend in a shape like a zigzag line, a curve, or a straight line in a plane, and may be flexibly selected and designed based on a structure of the feeding network 216. In some embodiments, the flat transmission line 260 of a specific shape may be first pre-processed and prepared, and then assembled in the antenna 21.

As described above, based on a basic structure of the phase shifter 261, a cavity height direction of the external conductor cavity 2620 of the phase shifter 261 may be defined as the width direction D4 of the phase shifter 261. It can be seen from FIG. 2A and FIG. 2B that a size in the width direction D4 of the phase shifter 261 is less than a size in a height direction of the phase shifter 261 (in FIG. 2A and FIG. 2B, the height direction of the phase shifter 261 is orthogonal to the reflection plate 214).

In this embodiment of this application, the width direction D4 of the phase shifter 261 may be parallel to the reflection plate 214 or orthogonal to the reflection plate 214. As shown in FIG. 2B, when the width direction D4 of the phase shifter 261 is parallel to the reflection plate 214, because the size in the width direction D4 of the phase shifter 261 is small, a size occupied by the phase shifter 261 in the width direction D4 is small accordingly. In some embodiments, when the width direction D4 of the phase shifter 261 is orthogonal to the reflection plate 214, because the size in the width direction D4 of the phase shifter 261 is small, the size occupied by the phase shifter 261 in the direction orthogonal to the reflection plate 214 is small accordingly. The phase shifter 261 may be flexibly disposed based on a design requirement of the antenna 21. This is not specifically limited in this application.

In this embodiment of this application, the phase shifter 261 may be disposed on the first surface 41 or the second surface 42 of the reflection plate 214, and the flat transmission line 260 may be flexibly designed based on a disposition form of the phase shifter 261.

As shown in FIG. 2A and FIG. 2B, in some embodiments, the phase shifter 261 may be disposed on the second surface 42 of the reflection plate 214, and the width direction D4 of the phase shifter 261 is parallel to the reflection plate 214. In this embodiment, the phase shifter 261 includes a first portion 2611 and a second portion 2612 that protrudes from the first portion 2611. The second portion 2612 extends between the transmission module 217 and the reflection plate 214. The flat transmission line 260 includes a first extension section 601, a second extension section 602, and a third extension section 603 that are sequentially connected. The first extension section 601 is located between the transmission module 217 and the second portion 2612 of the phase shifter 261, and the third extension section 603 is located on a side of the first portion 2611 of the phase shifter 261 away from the reflection plate 214. The flat transmission line 260 is approximately in a “Z” shape.

As described above, compared with a conventional round cable, the flat transmission line 260 is more likely to implement a bending and routing design. Therefore, the flat transmission line 260 may be designed as a “Z”-shaped trace according to a requirement. The flat transmission line 260 may be the strip line 61, the microstrip line 62, or the coplanar waveguide 63 in the foregoing embodiment. The width direction D2 of the flat transmission line 260 may be parallel to or orthogonal to the reflection plate 214. For a selection design of the flat transmission line 260, refer to the foregoing embodiment. Details are not described herein again. In addition, in this embodiment, the flat transmission line 260 is shown as a line clamp 607 for routing outside the phase shifter 261. In some other embodiments of this application, at least a portion of the flat transmission line 260 may be integrated with the phase shifter 261. For example, as shown in FIG. 7B, the ground plane 651 of the flat transmission line 260 and the phase shifter 261 are integrated and prepared together, and at least a portion of the signal transmission strip line 650 of the flat transmission line 260 is routed in the external conductor cavity 2620 of the phase shifter 261.

In this embodiment, the width direction D4 of the phase shifter 261 is parallel to the reflection plate 214. Because the size in the width direction D4 of the phase shifter 261 is small, a size occupied by the phase shifter 261 in the width direction D4 is small accordingly. The second portion 2612 of the phase shifter 261 protrudes from the first portion 2611 and extends between the transmission module 217 and the reflection plate 214. In this design, in one aspect, the transmission line between the phase shifter 261 and each radiating element 2150 may be shortened as much as possible, to reduce a signal transmission loss as much as possible. In another aspect, because the phase shifter 261 is closer to the end cover 212, a routing length of the flat transmission line 260 can be reduced, to reduce the signal transmission loss as much as possible. In still another aspect, the internal structure of the antenna 21 may be more compact. In some embodiments, the radiating element 2150 may be connected to the phase shift circuit of the phase shifter 261 through the reflection plate 214.

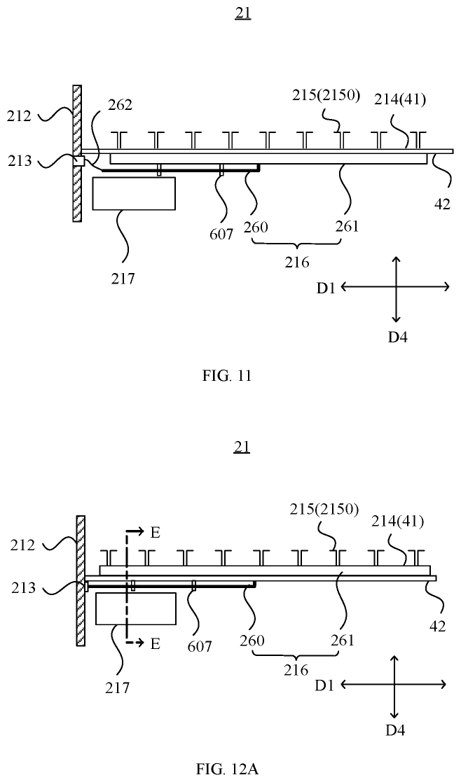

As shown in FIG. 10, in some embodiments, the phase shifter 261 may be disposed on the second surface 42 of the reflection plate 214, the width direction D4 (not shown in the figure, and is a direction perpendicular to a paper surface) of the phase shifter 261 is parallel to the reflection plate 214, and the flat transmission line 260 and the phase shifter 261 are laid out on the second surface 42 of the reflection plate 214.

That “the flat transmission line 260 and the phase shifter 261 are laid out on the second surface 42 of the reflection plate 214” may be understood as that orthographic projections of the flat transmission line 260 and the phase shifter 261 on the reflection plate 214 hardly overlap, and the flat transmission line 260 may be routed along an outer side surface of the phase shifter 261 orthogonal to the reflection plate 214. When there are two flat transmission lines 260, the two flat transmission lines 260 may be routed along two opposite outer side surfaces of the phase shifter 261 respectively. (The figure shows a front view of the antenna 21, and therefore only one flat transmission line 260 on one side is shown in the figure.) The flat transmission line 260 may be in a “straight-line” shape, or may be in another shape in a plane parallel to the reflection plate 214. This is not specifically limited in this application.

In this embodiment, the width direction D4 of the phase shifter 261 is parallel to the reflection plate 214. Because the size in the width direction D4 of the phase shifter 261 is small, a size occupied by the phase shifter 261 in the width direction D4 is small accordingly.

In this embodiment, the phase shifter 261 is located on a side of the transmission module 217 away from the end cover 212. Some radiating elements 2150 may not be opposite to the phase shifter 261. These radiating elements 2150 may be connected to the phase shift circuit of the phase shifter 261 through a flexible cable (not shown in the figure) that passes through the reflection plate 214. In some other embodiments, for a design of the phase shifter 261, refer to FIG. 2A. The phase shifter 261 includes a first portion 2611 and a second portion 2612 that protrudes from the first portion 2611. The second portion 2612 extends between the transmission module 217 and the reflection plate 214. The flat transmission line 260 and the phase shifter 261 are laid out on the second surface 42 of the reflection plate 214.

The flat transmission line 260 may be the strip line 61, the microstrip line 62, or the coplanar waveguide 63 in the foregoing embodiment, and a width direction of the flat transmission line 260 may be parallel to or orthogonal to the reflection plate 214. For a selection design of the flat transmission line 260, refer to the foregoing embodiment. Details are not described herein again. In addition, in this embodiment, the flat transmission line 260 is shown as a line clamp 607 for routing outside the phase shifter 261. In some other embodiments of this application, as shown in FIG. 7E, at least a portion of the flat transmission line 260 may be integrated with the phase shifter 261.

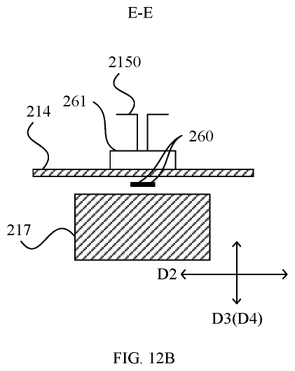

As shown in FIG. 11, in some embodiments, the phase shifter 261 may be disposed on the second surface 42 of the reflection plate 214, and the width direction D4 of the phase shifter 261 is orthogonal to the reflection plate 214. A portion of the phase shifter 261 extends between the transmission module 217 and the reflection plate 214, and a portion of the flat transmission line 260 is located between the transmission module 217 and the phase shifter 261. The flat transmission line 260 may be approximately in a “straight-line” shape, or may be in another shape in a plane parallel to the reflection plate 214. This is not specifically limited in this application.

In this embodiment, the width direction D4 of the phase shifter 261 is orthogonal to the reflection plate 214, because the size in the width direction D4 of the phase shifter 261 is small, the size occupied by the phase shifter 261 in the direction orthogonal to the reflection plate 214 is small accordingly. A portion of the phase shifter 261 extends between the transmission module 217 and the reflection plate 214. In this design, in one aspect, the transmission line between the phase shifter 261 and each radiating element 2150 may be shortened as much as possible, to reduce a signal transmission loss as much as possible. In another aspect, because the phase shifter 261 is closer to the end cover 212, a routing length of the flat transmission line 260 can be reduced, to reduce the signal transmission loss as much as possible. In still another aspect, the internal structure of the antenna 21 may be more compact. In some embodiments, the radiating element 2150 may be connected to the phase shift circuit of the phase shifter 261 through the reflection plate 214.

The flat transmission line 260 may be the strip line 61, the microstrip line 62, or the coplanar waveguide 63 in the foregoing embodiment, and a width direction of the flat transmission line 260 may be parallel to or orthogonal to the reflection plate 214. For a selection design of the flat transmission line 260, refer to the foregoing embodiment. Details are not described herein again. In addition, in this embodiment, the flat transmission line 260 is shown as a line clamp 607 for routing outside the phase shifter 261. In some other embodiments of this application, at least a portion of the flat transmission line 260 may be integrated with the phase shifter 261.

As shown in FIG. 12A and FIG. 12B, in some embodiments, the phase shifter 261 is disposed on the first surface 41 of the reflection plate 214, and the width direction D4 of the phase shifter 261 is orthogonal to the reflection plate 214. The radiating element array 115 is located on a side of the phase shifter 261 away from the reflection plate 214, and the flat transmission line 260 is connected to the phase shifter 261 through an electrical connection structure that penetrates the reflection plate 214. The reflection plate 214 may be provided with a via hole. The electrical connection structure may be, for example, a conducting wire that passes through the via hole and is insulated and isolated from the reflection plate 214, or a via metal that is disposed in the via hole and is insulated and isolated from the reflection plate 214. The flat transmission line 260 may be approximately in a “straight-line” shape, or may be in another shape in a plane parallel to the reflection plate 214. This is not specifically limited in this application.

The flat transmission line 260 may be the strip line 61, the microstrip line 62, or the coplanar waveguide 63 in the foregoing embodiment, and a width direction of the flat transmission line 260 may be parallel to or orthogonal to the reflection plate 214. For a selection design of the flat transmission line 260, refer to the foregoing embodiment. Details are not described herein again.

In this embodiment, the width direction D4 of the phase shifter 261 is orthogonal to the reflection plate 214, because the size in the width direction D4 of the phase shifter 261 is small, the size occupied by the phase shifter 261 in the direction orthogonal to the reflection plate 214 is small accordingly. In addition, in this embodiment, the phase shifter 261 is disposed on the first surface 41 of the reflection plate 214, and may be closer to the end cover 212. In one aspect, it is more convenient to connect the phase shifter 261 to each radiating element 2150, and a transmission line between the phase shifter 261 and each radiating element 2150 may be shortened as much as possible, to reduce a signal transmission loss as much as possible. In another aspect, a routing length of the flat transmission line 260 may be reduced, to reduce the signal transmission loss as much as possible. In still another aspect, the internal structure of the antenna 21 may be more compact.

In the foregoing embodiment, because a portion of the flat transmission line 260 is routed between the transmission module 217 and the reflection plate 214, an internal structure of the antenna 21 is compact and tidy, and it is convenient for the antenna 21 to implement a multi-frequency design. In addition, compared with a conventional round cable, the flat transmission line 260 can be used to reduce a transmission loss of the main feeder, thereby improving energy efficiency of the antenna 21.

An embodiment of this application further provides a phase shifter that may be used in an antenna. As shown in FIG. 7A, the phase shifter includes an external conductor cavity 2620, a phase shift component 2640, a phase shift circuit 2630, and a flat transmission line 260. The external conductor cavity 2620 is grounded. The phase shift component 2640 is disposed in the external conductor cavity 2620 and configured to be driven by a transmission module (for example, the transmission module 217 shown in FIG. 2A) of the antenna to execute a phase shift. The phase shift circuit 2630 is disposed in the external conductor cavity 2620, and the phase shift circuit 2630 includes an input/output main line 2631. The flat transmission line 260 includes a signal transmission strip line 650 and a ground plane 651 that is spaced apart from the signal transmission strip line 650. The signal transmission strip line 650 is connected to the input/output main line 2631, at least a portion of the signal transmission strip line 650 is located in the external conductor cavity 2620, and the ground plane 651 and the external conductor cavity 2620 are integrally connected to each other.

In some embodiments, the signal transmission strip line 650 and the input/output main line 2631 are welded, integrally connected to each other (as shown in FIG. 7C), or connected to each other through a bridge 204 (as shown in FIG. 7E and FIG. 7F).

In some embodiments, the external conductor cavity 2620 includes a plurality of sub-cavities 201, where at least a portion of the signal transmission strip line 650 and the input/output main line 2631 are located in a same sub-cavity 201 (as shown in FIG. 7C), or at least a portion of the signal transmission strip line 650 and the input/output main line 2631 are located in different sub-cavities 201 (as shown in FIG. 7E and FIG. 7F).

In some embodiments, the flat transmission line 260 is one of a strip line, a microstrip line, or a coplanar waveguide. For a specific structural design of the flat transmission line 260, refer to the descriptions in the foregoing embodiments. Details are not described herein again.

For a specific structure of the phase shifter 261, refer to the foregoing description of the phase shifter 261 in the antenna 21. Details are not described herein again. The phase shifter 261 in this embodiment of this application may be used in an antenna, where the antenna is not limited to the antenna 21 described in the foregoing embodiments.

In this embodiment of this application, the flat transmission line 260 of the phase shifter 261 may be used as a main feeder of the antenna. In comparison with a conventional round cable, a cross-sectional area of the flat transmission line may be designed to be larger, and a volume proportion of an insulating medium in the structure may be designed to be smaller. Therefore, a transmission loss is smaller, and energy efficiency of the antenna is improved. As shown in FIG. 2A, when the flat transmission line 260 is routed between the transmission module 217 and the reflection plate 214 of the antenna 21, the flat transmission line 260 may be disposed through a gap between the transmission module 217 and the reflection plate 214. In this way, the internal structure of the antenna 21 may be more compact and tidier.

An embodiment of this application further provides a base station, including the antenna 21 according to any one of the foregoing embodiments. Based on the foregoing beneficial effects of the antenna 21, the base station can also obtain corresponding beneficial effects, so that the base station has better network coverage performance.

The technical solutions in embodiments of this application may be applied to various communication systems, for example, a global system for mobile communications (global system for mobile communications, GSM) system, a code division multiple access (code division multiple access, CDMA) system, a wideband code division multiple access (wideband code division multiple access, WCDMA) system, a general packet radio service (general packet radio service, GPRS), a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, a 5th generation (5th generation, 5G) system, a new radio (new radio, NR) system, a future communication system, or the like.

The access network device described in embodiments of this application is sometimes referred to as an access node. The access network device has a wireless transceiver function and is configured to communicate with a terminal. The access network device includes but is not limited to a base station (base station) in the foregoing communication system, an evolved NodeB (evolved NodeB, eNodeB), a transmission reception point (transmission reception point, TRP), a next generation NodeB (next generation NodeB, gNB) in a 5G mobile communication system, a next generation base station in a 6th generation (6th generation, 6G) mobile communication system, an access network device or a module of an access network device in an open access network (open RAN, ORAN) system, a base station in a future mobile communication system, an access node in a Wi-Fi (wireless fidelity) system, or the like.

In some embodiments, the access network device may be a module or unit that can implement some functions of the base station. For example, the access network device may be a central unit (central unit, CU), a distributed unit (distributed unit, DU), a CU-control plane (control plane, CP), a CU-user plane (user plane, UP), a radio unit (radio unit, RU), or the like. In the ORAN system, the CU may also be referred to as an O (open, O)-CU, the DU may also be referred to as an O-DU, the CU-CP may also be referred to as an O-CU-CP, the CU-UP may also be referred to as an O-CU-UP, and the RU may also be referred to as an O-RU.

In some embodiments, the access network device may be a macro base station, a micro base station, an indoor base station, a relay node, a donor node, a radio controller in a cloud radio access network (cloud radio access network, CRAN) scenario, or the like. The macro base station may also be referred to as a macro cell base station, and may cover a large area, for example, a city or a village. The macro base station generally has high transmit power and a long communication distance, and may support simultaneous communication of a large quantity of users. The micro base station may also be referred to as a micro cell base station. Compared with the macro base station, the micro base station has a small coverage range and is usually used in densely populated regions such as cities, business districts, and indoors. The micro base station has low transmit power and a short communication distance, and can usually provide a higher network capacity and better signal quality. The indoor base station is a base station that can be used in an indoor environment, and may be installed in an indoor place like a large building, a shopping mall, an airport, or a subway, to provide indoor wireless communication coverage.

In some embodiments, the access network device may alternatively be a server, a wearable device, a vehicle-mounted device, or the like. For example, an access network device in a vehicle-to-everything (vehicle-to-everything, V2X) technology may be a road side unit (road side unit, RSU).

In embodiments of this application, a plurality of access network devices in the communication system may be base stations of a same type, or may be base stations of different types. The base station may communicate with a terminal, or may communicate with a terminal through a relay station. The terminal may communicate with a plurality of base stations in different access technologies. This is not specifically limited in this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising:
a reflection plate, comprising a first surface and a second surface;
a radiating element array, disposed on the first surface of the reflection plate;
an end cover, disposed at an end of the reflection plate in a longitudinal direction;
a connector, disposed on the end cover;
a feeding network, connected to the connector and the radiating element array, wherein the feeding network comprises a phase shifter and a transmission line, and the transmission line comprises a flat transmission line for signal transmission between the connector and the phase shifter; and
a transmission module, disposed on the second surface of the reflection plate and adjacent to the end cover, wherein the transmission module is configured to drive the phase shifter to execute a phase shift, and a portion of the flat transmission line is located between the transmission module and the reflection plate.

2. The antenna according to claim 1, wherein
the flat transmission line comprises a signal transmission strip line and a ground plane disposed apart from the signal transmission strip line, wherein a width direction of the signal transmission strip line is parallel to the reflection plate, or a thickness direction of the signal transmission strip line is parallel to the reflection plate.

3. The antenna according to claim 2, wherein
an air gap is provided between the signal transmission strip line and the ground plane.

4. The antenna according to claim 3, wherein
the flat transmission line is a strip line, and the ground plane comprises two ground plates disposed parallel to the signal transmission strip line, wherein the signal transmission strip line is located between the two ground plates, the signal transmission strip line is spaced apart from the two ground plates by a plurality of insulating support structures, and the air gap is separately provided between the signal transmission strip line and the two ground plates; or
the flat transmission line is a microstrip line, and the ground plane comprises one ground plate disposed parallel to the signal transmission strip line, wherein the signal transmission strip line is spaced apart from the one ground plate by a plurality of insulating support structures, and the air gap is provided between the signal transmission strip line and the one ground plate; or
the flat transmission line is a coplanar waveguide, the ground plane comprises a first wide side surface and a second wide side surface that are disposed in parallel, and a first narrow side surface and a second narrow side surface that are disposed in parallel, wherein the first wide side surface, the second wide side surface, the first narrow side surface, and the second narrow side surface form a rectangular cavity, the air gap is provided in the rectangular cavity, the first wide side surface has a strip-shaped opening, the signal transmission strip line is located in the strip-shaped opening, and the signal transmission strip line is spaced apart from the second wide side surface by a plurality of insulating support structures.

5. The antenna according to claim 2, wherein
the flat transmission line is a strip line, and the ground plane comprises two ground plates disposed parallel to the signal transmission strip line, wherein the signal transmission strip line is located between the two ground plates, and an insulating medium is filled between the signal transmission strip line and the two ground plates; or
the flat transmission line is a microstrip line, the ground plane comprises one ground plate disposed parallel to the signal transmission strip line, and an insulating medium is filled between the signal transmission strip line and the one ground plate; or
the flat transmission line is a coplanar waveguide, the ground plane comprises a first wide side surface and a second wide side surface that are disposed in parallel, and a first narrow side surface and a second narrow side surface that are disposed in parallel, wherein the first wide side surface, the second wide side surface, the first narrow side surface, and the second narrow side surface form a rectangular cavity, the rectangular cavity is filled with an insulating medium, the first wide side surface has a strip-shaped opening, and the signal transmission strip line is located in the strip-shaped opening.

6. The antenna according to claim 2, wherein
the flat transmission line is a strip line, the ground plane comprises a first wide side surface and a second wide side surface that are disposed in parallel, and a first narrow side surface and a second narrow side surface that are disposed in parallel, wherein the first wide side surface, the second wide side surface, the first narrow side surface, and the second narrow side surface form a rectangular cavity, the signal transmission strip line is located in the rectangular cavity and disposed parallel to the first wide side surface and the second wide side surface, and an insulating medium is filled in or an air gap is provided in the rectangular cavity.

7. The antenna according to claim 2, wherein
the transmission line comprises at least two flat transmission lines that extend in parallel and are configured to transmit signals in different polarization directions.

8. The antenna according to claim 7, wherein
ground planes of the at least two flat transmission lines are integrally connected to each other.

9. The antenna according to claim 2, wherein
the reflection plate is grounded, the width direction of the signal transmission strip line is parallel to the reflection plate, and at least a portion of the ground plane is integrated into the reflection plate.

10. The antenna according to claim 2, wherein
the phase shifter comprises an external conductor cavity that is grounded, and a phase shift component and a phase shift circuit that are disposed in the external conductor cavity, wherein the phase shift component is configured to be driven by the transmission module to execute a phase shift, the phase shift circuit comprises an input/output main line, the signal transmission strip line is connected to the input/output main line, at least a portion of the signal transmission strip line is located in the external conductor cavity, and the ground plane and the external conductor cavity are integrally connected to each other.

11. The antenna according to claim 10, wherein
the signal transmission strip line and the input/output main line are welded, integrally connected to each other, or connected to each other through a bridge.

12. The antenna according to claim 10, wherein
the external conductor cavity comprises a plurality of sub-cavities, wherein
the input/output main line and at least a portion of the signal transmission strip line are located in a same sub-cavity; or
the input/output main line and at least a portion of the signal transmission strip line are located in different sub-cavities.

13. The antenna according to claim 1, wherein
the transmission module is disposed opposite to one or more radiating elements that are in the radiating element array and adjacent to the end cover.

14. The antenna according to claim 13, wherein
an end of the flat transmission line away from the phase shifter extends, in the longitudinal direction, between the end cover and a first radiating element adjacent to the end cover; or
an end of the flat transmission line away from the phase shifter extends, in the longitudinal direction, between a first radiating element and a second radiating element that are adjacent to the end cover.

15. The antenna according to claim 1, wherein
the flat transmission line is fastened to at least one of the reflection plate, the transmission module, or the phase shifter through an insulating line clamp; or
the flat transmission line comprises a plurality of insulating mounting parts, and the plurality of insulating mounting parts are fastened to at least one of the reflection plate, the transmission module, or the phase shifter.

16. The antenna according to claim 1, wherein
the connector and an end of the flat transmission line away from the phase shifter are connected by welding, by plug-in, by a fastener, or by a flexible cable; or
the feeding network further comprises a function extension component, wherein the function extension component is disposed on the end cover, or the function extension component is disposed between the end cover and the transmission module, the connector is connected to the function extension component, and the function extension component and an end of the flat transmission line away from the phase shifter are connected by welding, by plug-in, by a fastener, or by a flexible cable.

17. The antenna according to claim 1, wherein
a width direction of the phase shifter is parallel or orthogonal to the reflection plate, wherein the phase shifter comprises the external conductor cavity that is grounded, the phase shift component and the phase shift circuit that are disposed in the external conductor cavity, and a cavity height direction of the external conductor cavity is defined as the width direction of the phase shifter.

18. A phase shifter, wherein the phase shifter is used in an antenna, and the phase shifter comprises:
an external conductor cavity, wherein the external conductor cavity is grounded;
a phase shift component, disposed in the external conductor cavity and configured to be driven by a transmission module of the antenna to execute a phase shift;
a phase shift circuit, disposed in the external conductor cavity, wherein the phase shift circuit comprises an input/output main line; and
a flat transmission line, comprising a signal transmission strip line and a ground plane spaced apart from the signal transmission strip line, wherein the signal transmission strip line is connected to the input/output main line, at least a portion of the signal transmission strip line is located in the external conductor cavity, and the ground plane and the external conductor cavity are integrally connected to each other.

19. The phase shifter according to claim 18, wherein
the signal transmission strip line and the input/output main line are welded, integrally connected to each other, or connected to each other through a bridge.

20. The phase shifter according to claim 18, wherein
the external conductor cavity comprises a plurality of sub-cavities, wherein
the input/output main line and at least a portion of the signal transmission strip line are located in a same sub-cavity; or
the input/output main line and at least a portion of the signal transmission strip line are located in different sub-cavities.
